(19) United States
(12) Patent Application Publication
(10) Pub. No.: US 2025/0290312 A1
(43) Pub. Date: Sep. 18, 2025

(54) Fire Shelter and Method

(71) Applicants: David E. Maust, Grantsville, MD (US); Joshua K. Behling, Salem, UT (US); Linda Cantey, Napa, CA (US); Michael Berube, Marietta, GA (US)

(72) Inventors: David E. Maust, Grantsville, MD (US); Joshua K. Behling, Salem, UT (US); Linda Cantey, Napa, CA (US); Michael Berube, Marietta, GA (US)

(73) Assignee: Strata Products Worldwide, LLC, Sandy Springs, GA (US)

(21) Appl. No.: 19/073,856

(22) Filed: Mar. 7, 2025

Related U.S. Application Data
(63) Continuation-in-part of application No. 18/605,612, filed on Mar. 14, 2024.

(51) Int. Cl. E04B 1/94; A62B 11/00; A62B 31/00; E04H 1/12; E06B 5/16; E06B 7/30

(52) U.S. Cl. CPC E04B 1/941; A62B 11/00; A62B 31/00; E04B 1/946; E04B 1/948; E04H 1/1205; E06B 5/162; E06B 7/30

(57) ABSTRACT

A shelter for protecting a person from fire and heat. The shelter has an inner door and an outer door and an outer door. The shelter has a roof, and front, right, left, and rear walls, each of which having a core made of a three-dimensional metal matrix embedded in insulation with concrete positioned about the walls and the roof. The concrete forming a fire-resistant seal with the base about the walls, and roof which protects the person in the chamber from fire and heat at least more than 700 degrees Fahrenheit for at least 4 hours. A method for protecting a person from fire and heat. A method for building a shelter for protecting a person from fire and heat external to the shelter.

### CROSS-REFERENCE TO RELATED APPLICATION

This is a continuation-in-part of U.S. patent application Ser. No. 18/605,612 filed Mar. 14, 2024, incorporated by reference herein.

### FIELD OF THE INVENTION

The present invention is related to a shelter for protecting a person from fire and heat. More specifically, the present invention is related to a shelter for protecting a person from fire and heat having a roof and walls, each having a core made of a three-dimensional metal matrix embedded in insulation with a one-piece concrete layer enveloping the roof, and the walls. The concrete layer forming a fire-resistant seal which protects the person in the chamber from fire and heat at least more than 700 degrees Fahrenheit for at least 4 hours.

### BACKGROUND OF THE INVENTION

This section is intended to introduce the reader to various aspects of the art that may be related to various aspects of the present invention. The following discussion is intended to provide information to facilitate a better understanding of the present invention. Accordingly, it should be understood that statements in the following discussion are to be read in this light, and not as admissions of prior art.

Whenever there is fire and heat in proximity to people and equipment, there is a need for protection for the people and the equipment from the fire and the heat. Regarding brush or forest fires that occur in densely populated communities, such as in California, these fires can move quickly without people having time to escape them. Once trapped, several hours can pass before the intense heat and fire dissipates enough for the trapped people to escape. What is needed in such circumstances is a portable fire shelter that can protect at least several people for several hours from the intense heat and fire which is convenient and unassuming.

### BRIEF SUMMARY OF THE INVENTION

The present invention pertains to a shelter for protecting a person from fire and heat external to the shelter. The shelter comprises a base. The shelter comprises a front wall extending up from the base. The shelter comprises a right wall extending up from the base and alongside the front wall. The shelter comprises a left wall extending up from the base and alongside the front wall. The shelter comprises a rear wall extending up from the base and alongside the front wall and the left wall and opposing the right wall. The shelter comprises a roof atop the front wall, the right wall, the left wall, and the rear wall which together define a protected chamber from fire. The roof, the front wall, the right wall, and the left wall each having a core made of a three-dimensional metal matrix embedded in insulation with concrete positioned about the front wall, the right wall, the left wall, the rear wall and the roof. The concrete forming a continuous one-piece concrete envelope 90 enveloping the roof, the front wall, the right wall, the left wall and the rear wall down to the base. The concrete layer forming a fire-resistant seal with the base about the front wall, right wall, left wall, rear wall and the roof which protects the person in the chamber from fire and heat at least more than 600 degrees Fahrenheit for at least 2 hours. The shelter comprises a fire-resistant door disposed in either the front wall, the right wall, the left wall or the left wall which provides access to the chamber.

The present invention pertains to a method for protecting a person from fire and heat. The method comprises the steps of closing a fire-resistant door of a shelter. The shelter comprises a base. The shelter comprises a front wall extending up from the base. The shelter comprises a right wall extending up from the base and alongside the front wall. The shelter comprises a left wall extending up from the base and alongside the front wall. The shelter comprises a rear wall extending up from the base and alongside the front wall and the left wall and opposing the right wall. The shelter comprises a roof atop the front wall, the right wall, the left wall and the rear wall which together define a protected chamber from fire. The roof, the front wall, the right wall and the left wall each having a core made of a three-dimensional metal matrix embedded in insulation with concrete positioned about the front wall, the right wall, the left wall, the rear wall and the roof. The concrete forming a continuous one-piece concrete envelope 90 enveloping the roof, the front wall, the right wall, the left wall, and the rear wall down to the base. The concrete layer forming a fire-resistant seal with the base about the front wall, right wall, left wall, rear wall and the roof which protects the person in the chamber from fire and heat at least more than 600 degrees Fahrenheit for at least 2 hours. The shelter comprises a fire-resistant door disposed in either the front wall, the right wall, the left wall or the left wall which provides access to the chamber. There is the step of opening valves of compressed air cylinders in the shelter to flow the compressed air from the cylinders into the chamber of the shelter.

The present invention pertains to a method for building a shelter for protecting a person from fire and heat external to the shelter. The method comprises the steps of placing a front wall on a base so the front wall is extending up from the base. There is the step of placing a right wall on a base so the right wall is extending up from the base and alongside the front wall. There is the step of placing a left wall on a base so the left wall is extending up from the base and alongside the front wall. There is the step of placing a rear wall on a base so the rear wall is extending up from the base and alongside the front wall and the left wall and opposing the right wall. There is the step of placing a roof atop the front wall, the right wall, the left wall, and the rear wall which together define a protected chamber from fire. The roof, the front wall, the right wall and the left wall each having a core made of a three-dimensional metal matrix embedded in insulation with concrete positioned about the front wall, the right wall, the left wall, the rear wall and the roof. There is the step of pouring concrete onto the roof which flows over the roof onto the front, right, left and rear walls and down to the base, forming a continuous one-piece concrete envelope 90 enveloping the roof, the front wall, the right wall, the left wall and the rear wall down to the base. The concrete layer forming a fire-resistant seal with the base about the front wall, right wall, left wall, rear wall and the roof which protects the person in the chamber from fire and heat at least more than 600 degrees Fahrenheit for at least 2 hours. There is the step of attaching a fire-resistant door disposed in either the front wall, the right wall, the left wall or the left wall which provides access to the chamber.

The present invention pertains to a shelter for protecting a person from fire and heat external to the shelter. The shelter comprises a base. The shelter comprises a front wall extending up from the base. The shelter comprises a right wall extending up from the base and alongside the front wall. The shelter comprises a left wall extending up from the base and alongside the front wall. The shelter comprises a rear wall extending up from the base and alongside the front wall and the left wall and opposing the right wall. The shelter comprises a roof atop the front wall, the right wall, the left wall and the rear wall which together define a protected chamber from fire. The roof, the front wall, the right wall and the left wall each having a core made of a three-dimensional metal matrix embedded in and extending through insulation with concrete positioned about the front wall, the right wall, the left wall, the rear wall and the roof. The shelter comprises an outer fire-resistant door disposed in either the front wall, the right wall, the left wall or the left wall which provides access to the chamber. The outer fire-resistant door containing fire- and heat-resistant insulation. The shelter comprises an inner fire-resistant door which provides access to the chamber. The inner fire-resistant door disposed adjacent to the outer fire-resistant door with an air gap disposed between the inner and the outer fire-resistant doors. The inner fire-resistant door containing fire- and heat-resistant insulation. The roof, the inner and outer doors, the front wall, the right wall, the left wall, the rear wall, the concrete layer, and the base protect the person in the chamber from fire and heat at least in excess of 600 degrees Fahrenheit for at least 2 hours.

The present invention pertains to a method for protecting a person from fire and heat. The method comprises the steps of closing an outer fire-resistant door of a shelter. There is the step of closing an inner fire-resistant door of the shelter. The shelter comprises a base. The shelter comprises a front wall extending up from the base. The shelter comprises a right wall extending up from the base and alongside the front wall. The shelter comprises a left wall extending up from the base and alongside the front wall. The shelter comprises a rear wall extending up from the base and alongside the front wall and the left wall and opposing the right wall. The shelter comprises a roof atop the front wall, the right wall, the left wall and the rear wall which together define a protected chamber from fire. The roof, the front wall, the right wall and the left wall each having a core made of a three-dimensional metal matrix embedded in and extending through insulation with concrete positioned about the front wall, the right wall, the left wall, the rear wall and the roof. The shelter comprises an outer fire-resistant door disposed in either the front wall, the right wall, the left wall or the left wall which provides access to the chamber. The outer fire-resistant door containing fire- and heat-resistant insulation. The shelter comprises an inner fire-resistant door which provides access to the chamber. The inner fire-resistant door disposed adjacent to the outer fire-resistant door with an air gap disposed between the inner and the outer fire-resistant doors. The inner fire-resistant door containing fire- and heat-resistant insulation. The roof, the inner and outer doors, the front wall, the right wall, the left wall, the rear wall, the concrete layer, and the base protect the person in the chamber from fire and heat at least in excess of 600 degrees Fahrenheit for at least 2 hours. There is the step of opening valves of compressed air cylinders in the shelter to flow the compressed air from the cylinders into the chamber of the shelter.

The present invention pertains to a method for building a shelter for protecting a person from fire and heat external to the shelter. The method comprises the steps of placing a front wall on a base so the front wall is extending up from the base. There is the step of placing a right wall on a base so the right wall is extending up from the base and alongside the front wall. There is the step of placing a left wall on a base so the left wall is extending up from the base and alongside the front wall. There is the step of placing a rear wall on a base so the rear wall is extending up from the base and alongside the front wall and the left wall and opposing the right wall. There is the step of placing a roof atop the front wall, the right wall, the left wall and the rear wall which together define a protected chamber from fire. The roof, the front wall, the right wall and the left wall each having a core made of a three-dimensional metal matrix embedded in insulation with concrete positioned about the front wall, the right wall, the left wall, the rear wall and the roof. There is the step of fixing an outer fire-resistant door in either the front wall, the right wall, the left wall or the left wall which provides access to the chamber. The outer fire-resistant door containing fire- and heat-resistant insulation. There is the step of fixing an inner fire-resistant door which provides access to the chamber adjacent to the outer fire-resistant door with an air gap disposed between the inner and the outer fire-resistant doors. The inner fire-resistant door containing fire- and heat-resistant insulation. The roof, the inner and outer doors, the front wall, the right wall, the left wall, the rear wall, the concrete layer, and the base protect the person in the chamber from fire and heat at least in excess of 600 degrees Fahrenheit for at least 2 hours.

### BRIEF DESCRIPTION OF THE DRAWINGS

FIG. 1 is a perspective view of a shelter of the present invention.

FIG. 2 is an overhead perspective cut away view of a chamber of the shelter with only some of the cores of the walls.

FIG. 3 is a cutaway side view representation of a wall or roof.

FIG. 4 is an overhead view of the shelter with the roof removed.

FIG. 5 is a representation of the plumbing connected to the pressurized air cylinders inside the chamber.

FIG. 6 is a perspective view of the base with the doorframe.

FIG. 7 is an overhead view of the base.

FIG. 8 is a perspective view of the doorframe and mount with rebar poles.

FIG. 9 is a perspective view of the skeleton of the base.

FIG. 10 is a side view of a longitudinal bracket of the skeleton.

FIG. 11 right side cutaway view of the shelter showing the chamber.

FIG. 12 is a cross-sectional from view of the concrete envelope on the base,

FIG. 13 is a perspective view of the core walls.

FIG. 14 shows a cross-sectional view of a side of the alternative embodiment.

FIG. 15 shows a cross-sectional view of a lower weld and a base seal.

FIG. 16 shows a cross-sectional view of a roof seal.

FIG. 17 shows weld locations regarding the rear wall.

FIG. 18 shows weld locations regarding the left wall.

FIG. 19 shows weld locations regarding the front wall.

FIG. 20 shows weld locations regarding the right wall.

FIG. 21 shows a cross-sectional view of a lower weld.

FIG. 22 shows a cross-sectional view of an upper weld.

FIG. 23 shows an inner door and an outer door.

FIG. 24 shows the outer door without the remainder of the front wall.

FIG. 25 shows the front wall with the outer door.

FIG. 26 shows and inner view of the outer door.

FIG. 27 shows the hatch of the outer door.

FIG. 28 shows a cross-sectional view of the inner door and the outer door.

FIG. 29 is a perspective view of a dolly.

FIG. 30 is an overhead view of the dolly.

FIG. 31 is a side view of the dolly.

FIG. 32 is a front view of the dolly.

FIG. 33 is a rear view of the dolly.

FIG. 34 is a perspective view of a linkage extending from a rear end of a skeleton of the dolly.

FIG. 35 is a perspective view of a portion of the front wheel assembly which engages with the linkage.

FIG. 36 is a perspective view of a bar of the front wheel assembly.

FIG. 37 is a perspective view of a post of a rear wheel assembly.

FIG. 38 is a perspective view of an alternative embodiment of a dolly.

FIG. 39 is an exploded perspective view of a first front tire assembly.

FIG. 40 is an overhead view of the shelter with an alternate internal design with the roof removed.

FIG. 41 is a side view of the shelter with the alternate internal design with the right side removed.

FIG. 42 is a perspective view of the base, walls and roof with their cores exposed in an alternative embodiment.

FIG. 43 is a perspective view of the shelter in an alternative embodiment.

### DETAILED DESCRIPTION OF THE INVENTION

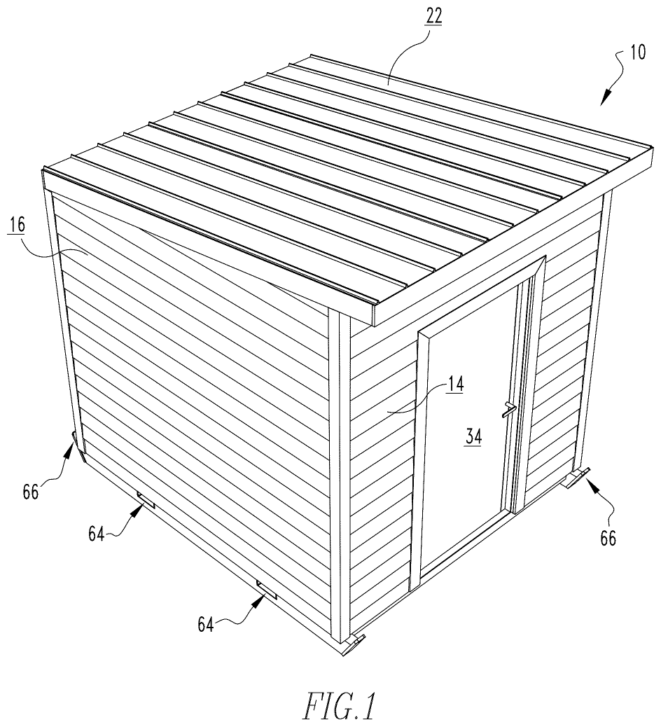

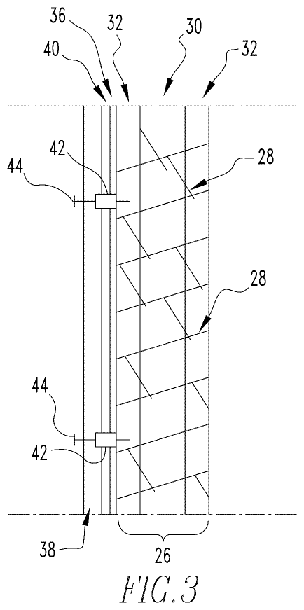

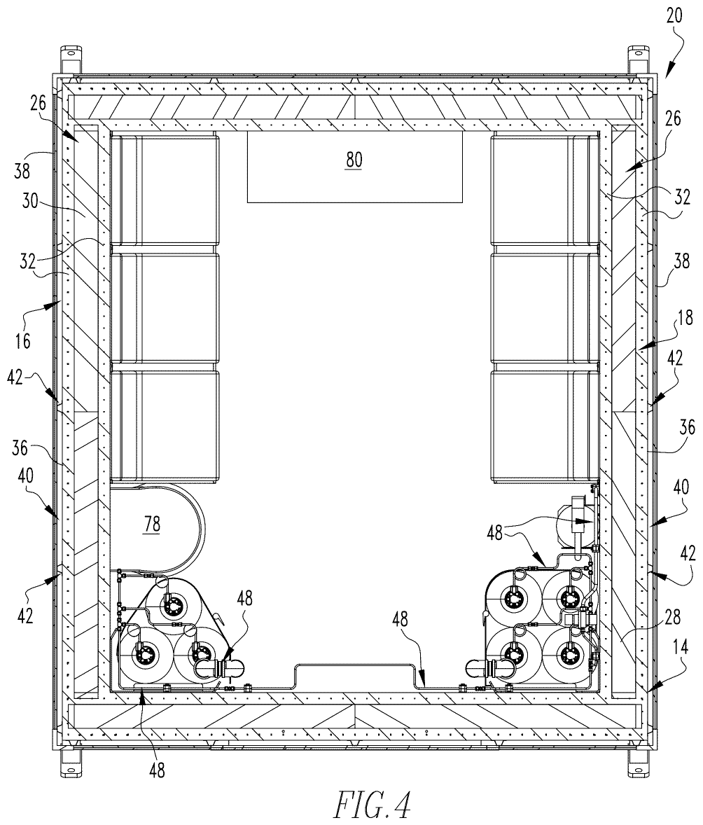

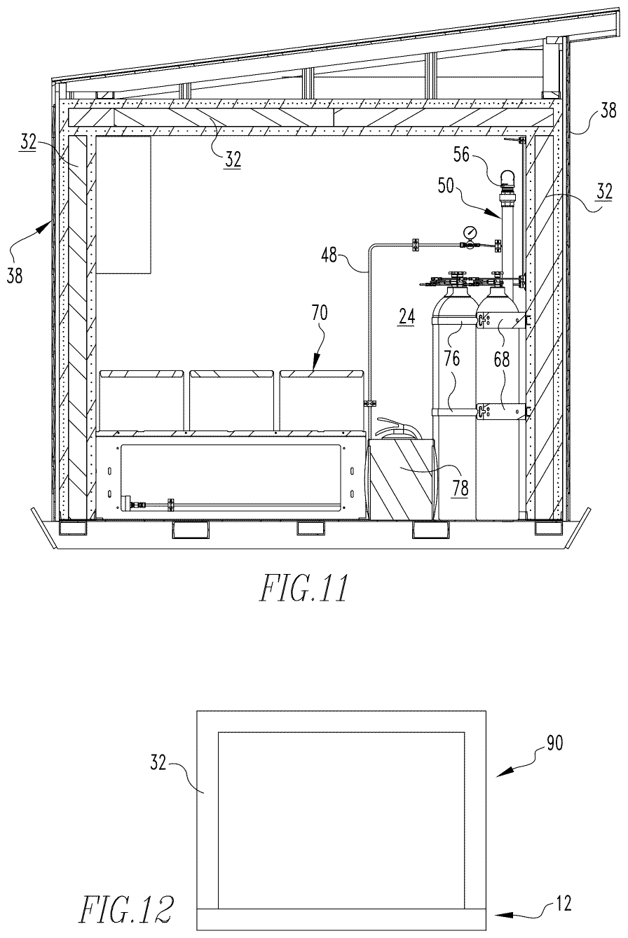

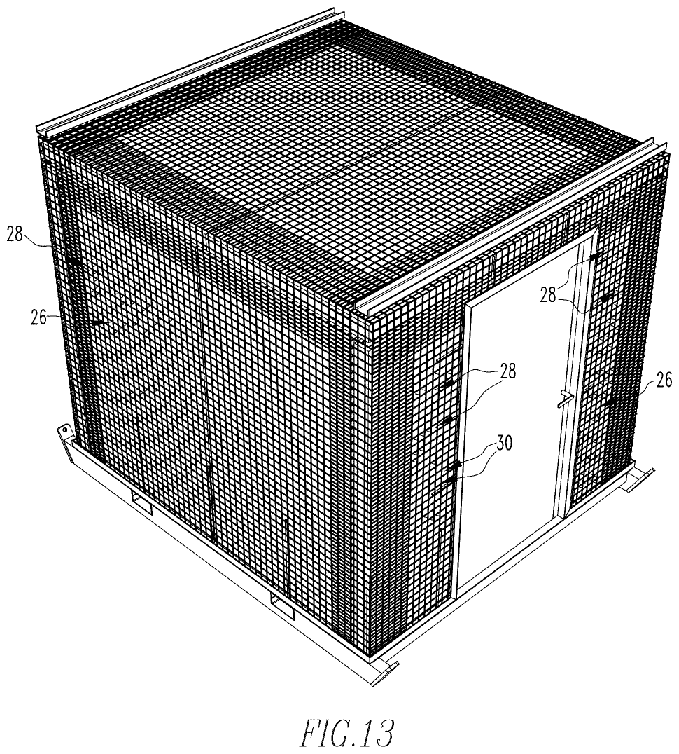

Referring now to the drawings wherein like reference numerals refer to similar or identical parts throughout the several views, and more specifically to FIGS. 1-4 thereof, there is shown a shelter 10 for protecting a person from fire and heat external to the shelter 10. The shelter 10 comprises a base 12. The shelter 10 comprises a front wall 14 extending up from the base 12. The shelter 10 comprises a right wall 16 extending up from the base 12 and alongside the front wall 14. The shelter 10 comprises a left wall 18 extending up from the base 12 and alongside the front wall 14. The shelter 10 comprises a rear wall 20 extending up from the base 12 and alongside the front wall 14 and the left wall 18 and opposing the right wall 16. The shelter 10 comprises a roof 22 atop the front wall 14, the right wall 16, the left wall 18, and the rear wall 20 which together define a protected chamber 24 from fire. The roof 22, the front wall 14, the right wall 16, and the left wall 18 each having a core 26 made of a three-dimensional metal matrix 28 embedded in insulation 30 with concrete 32 positioned about the front wall 14, the right wall 16, the left wall 18, the rear wall 20, and the roof 22. The concrete 32 forming a continuous one-piece concrete 32 envelope 90 enveloping the roof 22, the front wall 14, the right wall 16, the left wall 18, and the rear wall 20 down to the base 12, as shown in FIG. 12. The concrete 32 envelope 90 forming a fire-resistant seal with the base 12 about the front wall 14, right wall 16, left wall 18, rear wall 20 and the roof 22 which protects the person in the chamber 24 from fire and heat at least more than 600 degrees Fahrenheit and preferably 700 degrees Fahrenheit for at least 2 hours and preferably 4 hours and even 8 hours. The shelter 10 comprises a fire-resistant door 34 disposed in either the front wall 14, the right wall 16, the left wall 18, or the left wall 18 which provides access to the chamber 24. The insulation 30 may be a fire-resistant and heat limiting plastic or foam, such as polystyrene, that is much lighter weight per cubic ft than concrete. The size of the shelter 10 may be limited only by the contents being protected and for how long. Generally, there is 2 cubic feet of released air per occupant. For instance, for six adults to be sustained safely for 4 hours, there is a release of 12 CFM of air over 4 hours. This same rate is also applicable for 2 hours or 8 hours, depending how long the shelter 10 is to provide protection. The size of the shelter 10 for six adults is about 110 in. long and about 98 in. wide and about 120 in high. The chamber 24 is about 82 in. wide and about 94 in. long and about 108 in. high.

The shelter 10 may include a heat reflective layer 36 disposed on an external surface of each of the front wall 14, right wall 16, the left wall 18, the rear wall 20 and the roof 22. The shelter 10 may include an inflammable layer 38 in spaced relation to the reflective layer 36 on each of the front wall 14, the right wall 16, the left wall 18, the rear wall 20 and the roof 22 forming an airgap 40 between the inflammable layer 38 and the reflective layer 36 in each of the front wall 14, the right wall 16, the left wall 18, the rear wall 20, and the roof 22.

The shelter 10 may include inflammable heat resistant spacers 42 attached to and between the reflective layer 36 and the inflammable layer 38 of the front wall 14, the right wall 16, the left wall 18, the rear wall 20 and the roof 22 which maintain the inflammable layer 38 in spaced relation with the reflective layer 36 to define the airgap 40; and fasteners 44 extending through the inflammable layer 38, the spacers 42, the reflective layer 36 and the front wall 14, the right wall 16 the left wall 18, the rear wall 20, and the roof 22 to fix the inflammable layer 38, the spacers 42, and the reflective layer 36 in place with the front wall 14, the right wall 16, the left wall 18, the rear wall 20, and the roof 22. The shelter 10 may include a cylinder storage section 46 for storing compressed air cylinders 47 to provide air to the chamber 24.

The shelter 10 may include plumbing 48 disposed in the chamber 24 to attach to the cylinders to control air flow out of the cylinders into the chamber 24, as shown in FIG. 5. The shelter 10 may include a hollow pipe 50 extending up from a hole 84 in the base 12. The pipe 50 having a top 52 and a bottom 54. The top 52 having a one-way exhaust valve 56 through which air from the chamber 24 enters and vents through the pipe 50 and out through the base 12. The bottom 54 of the pipe 50 attached to the base 12 and in fluidic communication to outside the base 12. The shelter 10 may include a release port 58 for the compressed air from the air cylinders to flow into the chamber 24. The release port 58 in fluidic communication with the plumbing 48.

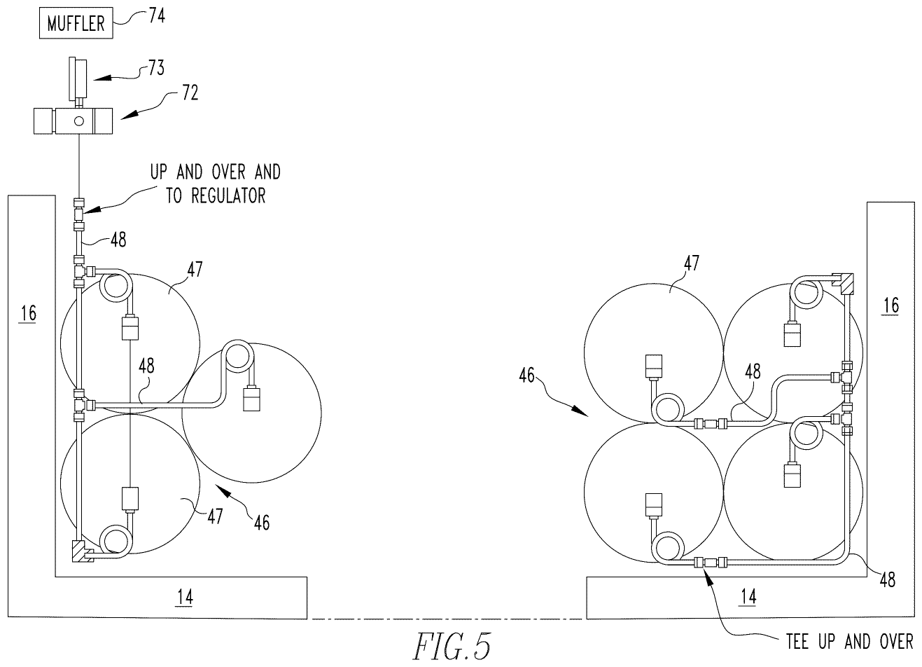

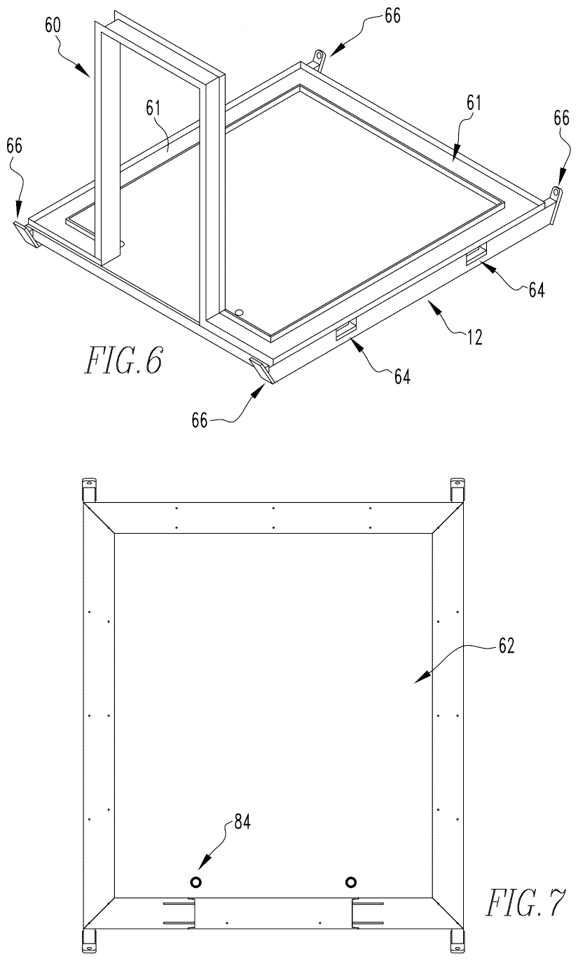

The release port 58 may be disposed adjacent the base 12 and the rear wall 20, and the pipe 50 is disposed adjacent the front wall 14 and opposing the release port 58 with the one-way exhaust valve 56 adjacent the roof 22 so isentropic cooling provided by the expansion of the compressed breathing air occurs. The inflammable layer 38 may be formed of cement board. The reflective layer 36 may be disposed on the external surface of each of the front wall 14, right wall 16, the left wall 18, and the rear wall 20 is one piece. The shelter 10 may include a metal frame 60 in the front wall 14 to which the door 34 is attached, as shown in FIG. 6 and FIG. 7. The base 12 may include a steel platform 62 with fork pockets 64 and lifting eye 66 at each corner for lifting the shelter 10. The core 26 of each wall and the roof 22 may include an EVG panel.

The present invention pertains to a method for protecting a person from fire and heat. The method comprises the steps of closing a fire-resistant door 34 of a shelter 10. The shelter 10 comprises a base 12. The shelter 10 comprises a front wall 14 extending up from the base 12. The shelter 10 comprises a right wall 16 extending up from the base 12 and alongside the front wall 14. The shelter 10 comprises a left wall 18 extending up from the base 12 and alongside the front wall 14. The shelter 10 comprises a rear wall 20 extending up from the base 12 and alongside the front wall 14 and the left wall 18 and opposing the right wall 16. The shelter 10 comprises a roof 22 atop the front wall 14, the right wall 16, the left wall 18 and the rear wall 20 which together define a protected chamber 24 from fire. The roof 22, the front wall 14, the right wall 16 and the left wall 18 each having a core 26 made of a three-dimensional metal matrix 28 embedded in insulation 30 with concrete 32 positioned about the front wall 14, the right wall 16, the left wall 18, the rear wall 20 and the roof 22. The concrete 32 forming a continuous one-piece concrete 32 envelope 90 enveloping the roof 22, the front wall 14, the right wall 16, the left wall 18, and the rear wall 20 down to the base 12. The concrete 32 envelope 90 forming a fire-resistant seal with the base 12 about the front wall 14, right wall 16, left wall 18, rear wall 20 and the roof 22 which protects the person in the chamber 24 from fire and heat at least more than 600 degrees Fahrenheit and preferably 700 degrees Fahrenheit for at least 2 hours and preferably 4 hours. The shelter 10 comprises a fire-resistant door 34 disposed in either the front wall 14, the right wall 16, the left wall 18 or the left wall 18 which provides access to the chamber 24. There is the step of opening valves of compressed air cylinders in the shelter 10 to flow the compressed air from the cylinders into the chamber 24 of the shelter 10.

The present invention pertains to a method for building a shelter 10 for protecting a person from fire and heat external to the shelter 10. The method comprises the steps of placing a front wall 14 on a base 12 so the front wall 14 is extending up from the base 12. There is the step of placing a right wall 16 on a base 12 so the right wall 16 is extending up from the base 12 and alongside the front wall 14. There is the step of placing a left wall 18 on a base 12 so the left wall 18 is extending up from the base 12 and alongside the front wall 14. There is the step of placing a rear wall 20 on a base 12 so the rear wall 20 is extending up from the base 12 and alongside the front wall 14 and the left wall 18 and opposing the right wall 16. There is the step of placing a roof 22 atop the front wall 14, the right wall 16, the left wall 18 and the rear wall 20 which together define a protected chamber 24 from fire. The roof 22, the front wall 14, the right wall 16 and the left wall 18 each having a core 26 made of a three-dimensional metal matrix 28 embedded in insulation 30 with concrete 32 positioned about the front wall 14, the right wall 16, the left wall 18, the rear wall 20 and the roof 22. There is the step of pouring concrete 32 onto the roof 22 which flows over the roof 22 onto the front, right, left and rear walls 14, 16, 18, 20 and down to the base 12, forming a continuous one-piece concrete 32 envelope 90 enveloping the roof 22, the front wall 14, the right wall 16, the left wall 18 and the rear wall 20 down to the base 12. The concrete 32 envelope 90 forming a fire-resistant seal with the base 12 about the front wall 14, right wall 16, left wall 18, rear wall 20 and the roof 22 which protects the person in the chamber 24 from fire and heat at least more than 600 degrees Fahrenheit and preferably 700 degrees Fahrenheit for at least 2 hours and preferably 4 hours and even 8 hours. There is the step of attaching a fire-resistant door 34 disposed in either the front wall 14, the right wall 16, the left wall 18 or the left wall 18 which provides access to the chamber 24.

In the operation of the invention, the shelter 10 protects inhabitants for at least 2 hours and preferably 4 hours and even 8 hours from heat and fire at least 600 degrees Fahrenheit and at least 700 degrees Fahrenheit, and preferably at least 1500 degrees Fahrenheit and at least 2000 degrees Fahrenheit. The wall/roof 22 thickness is approximately 7″ to 11″ and preferably 9″ thick. Starting from the inside, there is about 2″ of concrete 32 with embedded steel mesh, about 4″ of foam insulation 30, then about 2″ of concrete 32 with embedded steel mesh, radiant barrier foil, about a ¾″ air space created with steel furring, then cement board or other non-flammable siding on the outer surface. The concrete 32 may be between 1″ and 3″ and the foam insulation may be between 3″ and 5″. The air space may be between ¼″ and 1″.

The walls comprising the three-dimensional panels, such as EVG panels which can be purchased from Strata Products Worldwide, LLC., are formed while in position on the base 12. See FIG. 13, which shows the cores 26 of the walls, here EVG panels, in place on the base 12 ready for forms to be placed around them for the concrete 32 pouring. The roof 22 is formed separately and then placed on top of the 4 walls. To prevent heat and gases from getting in through any seams, concrete 32 is poured onto the completed roof 22 and the completed walls. The concrete 32 is a continuous pour which eliminates any seams except where it meets the base 12. The concrete 32 forms a one-piece envelope 90, enveloping the chamber 24 from the base 12 up. Alternatively, only the interior concrete layer may be formed on the 4 walls and the roof 22, and then after the roof 22 is positioned on the 4 walls, the concrete is poured so the concrete fills the outer side of the roof 22 and spills over and fills the outer side of each of the 4 walls so the one-piece concrete envelope 90 is formed. The concrete 32 is poured tight to the steel base 12 and door frame 60. The door 34 is welded to the frame 60 and non-flammable sealant applied to all joints. Additionally, the released compressed air provides a constant positive pressure to the chamber 24 relative to outside the shelter 10 throughout the entire desired period, such as a 4-hour period once turned open to further insure none of the external atmosphere enters the chamber.

The shelter 10 is berned around the perimeter with dirt/sand to prevent migration of heat through the base 12. Additionally, the shelter 10 is preferably installed with a 30′ perimeter clear of potential fuel, brush, trees, dead limbs, etc. to further lower the potential fire and heat to which the shelter 10 may be exposed. Therefore, the potential of exposure of elevated heat at floor level will be minimal at worst.

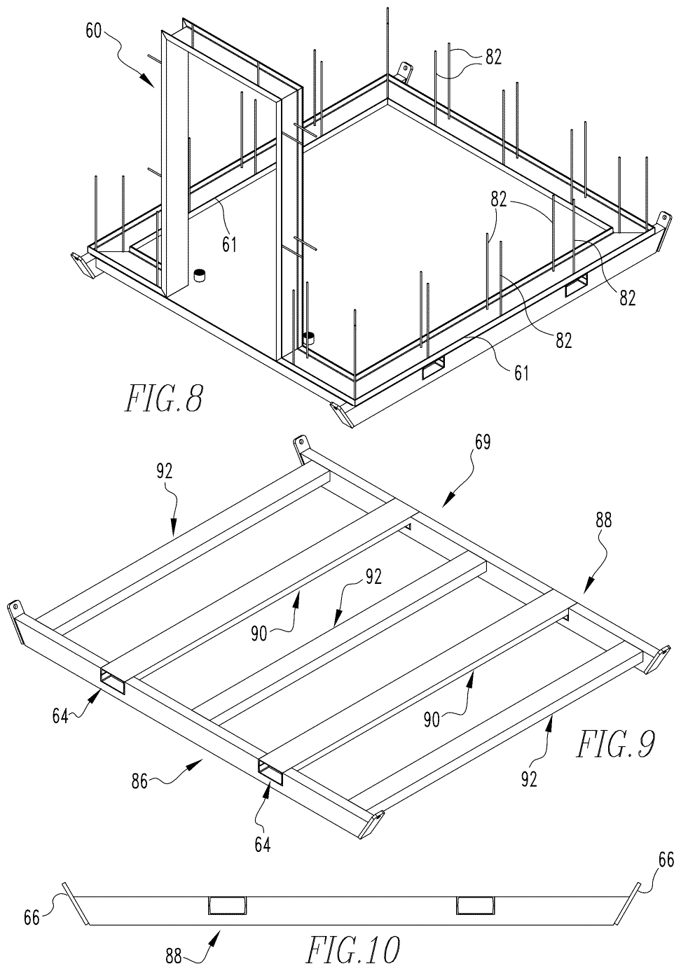

The individual EVG panels are cut to shape as necessary, for instance to accommodate the door frame 60, and positioned on the base 12. The base 12 has rebar poles 82 extending upwards between 1 and 4 ft from the base 12, around the perimeter of the base 12, as shown in FIG. 8. The rebar poles 82 serve to align the EVG panels in the proper position on the base 12. Preferably there are two opposing adjacent rebar pole 82 pairs staggered about the base 12 perimeter with at least one rebar pole 82 pair for each EVG panel. Each EVG panel is placed on the base 12 so one rebar pole 82 of the rebar pole 82 pair fits into the metal matrix 28 extending from the insulation 30 on one side, and the other rebar pole 82 of the rebar pole 82 pair fits into the metal matrix 28 extending from the other side of the insulation 30. The door frame 60 includes a support 61 which extends around the perimeter of a platform 62 of the base 12, from one side of the frame 60 to the other side of the frame 60. The rebar poles 82 are welded to the support 61 and the support 61 is in turn bolted or welded to the platform 62 and becomes part of the platform 62. The corners of each of the EVG panel walls are next connected to each other. Then forms are installed inside and out of each EVG panel in place on the base 12, with metal reinforcement mesh positioned in the forms outside the insulation 30, and concrete 32 is poured from the top 52. The forms are preferably aluminum and extend from the base 12 to above the EVG panels. The EVO panels forming the roof 22 are separately joined together and positioned in forms with metal reinforcement mesh, and have concrete 32 poured to them.

After the concrete 32 has properly cooled of the walls and the roof 22, depending on which one piece concrete envelope 90 forming method is used, the forms are removed, or the roof 22 is placed on top of the walls and secured to the walls, and the concrete poured to form the one-piece concrete envelope 90 about the chamber 24. A first reflective strip is placed on the roof 22 having a length extending from the top of the frame 60, across the roof 22 and partially down the rear side 20. A second reflective strip is placed on the roof 22 having a length extending partially down the right side 16, across the roof 22 and partially down the left side 18. The first and second reflective strips have a width which covers the width of the roof 22. A third reflective strip is wrapped around the front wall 14, right wall 16, rear wall 20 and left wall 18 from one side of the door frame 60 to the other side of the door frame 60, and extending from the base 12 to the roof 22, and overlapping the portions of the first and second reflective strips which extend past the roof 22 and downward. In this way the first, second and third reflective strips from a complete reflective layer 36 about the chamber 24 from the base 12 upwards and across the walls and roof 22. Metal furring strips, which also serve as spacers 42, are fastened to the walls and roof 22 at regular intervals, with the first, second and third reflective strips also fastened to the walls with the metal furring strips. The first and second reflective strips are also fastened to the roof 22 with metal furring strips, with the reflective strips positioned between the furring strips and the walls.

The reflective layer 36 is a heavy-duty radiant barrier that reflects/blocks 95% of the radiant heat, such as RadiantGUARD®. The reflective layer 36 is used under metal, slate, cement, clay, or any other roofing material, with preferably a ¾″ airspace in front of the reflective layer 36. The reflective strips are obtained from 48″ wide rolls. Joints are taped with foil tape. The reflective strips are secured to the outer surface of the concrete 32 walls and roof 22 with metal furring strips and concrete screws.

The base 12 is a welded steel platform 62 with fork pockets 64 and lifting eye 66 at each of the 4 corners to accommodate transport, loading and final positioning, as shown in FIGS. 6 and 7. The base 12 is formed of a skeleton 69, as shown in FIG. 9, with the platform 62 on the skeleton 69. The right longitudinal bracket 86 and left longitudinal bracket 88 of the skeleton 69 under the right and left walls 16, 18, respectively, have c shaped cutouts in which channels 90 are positioned and extend between the right and left longitudinal brackets. FIG. 10 shows a longitudinal bracket with a lifting eye 66 on each end of the bracket. In the middle between the channels 90 and adjacent the ends of the right and left longitudinal brackets are tubes 92 extending between the right and left longitudinal brackets. When the platform 62 is fastened or welded to the skeleton 69, the base 12 is formed. With the shelter 10 berned with earth and the 30′ radius cleared of fuel, heat gain via the steel platform 62 will be insignificant. In addition to the above, for the safety of the occupants in the chamber 24 are the following features:
Chemical toilet 70
Battery powered lighting with 10-year shelf-life batteries
Fire extinguisher
First Aid Kit
Battery power strobe light
Non-slip cushioned floor matting
Cabinets 80 for storage of safety and other equipment.

The inflammable layer 38 is the outer layer and is preferably but not necessarily fiber cement siding. It can be any inflammable skin. Fiber cement board siding is produced by several manufacturers. Hardie Plank is one of the available brands of fiber cement board siding which can be purchased. Steel siding could be used as well.

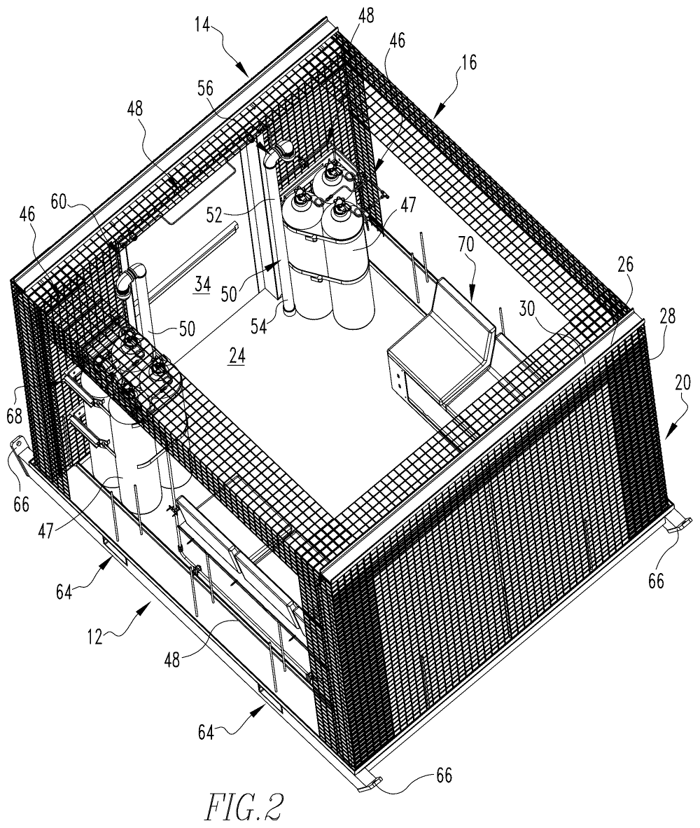

Breathable air is provided via 4500 PSI cylinders 47. Seven cylinders 47, as shown in FIGS. 2, 4 and 11 are required to sustain 6 adults for 4 hours. The cylinders 47, three on the right side and four on the left side, are held by cylinder brackets 68 mounted into the corners formed by the front wall 14 and the right wall 16, and the front wall 14 and the left wall 18. Straps 76 attached to the cylinder brackets 68 hold the cylinders 47 in place. The compressed air is released low and in the rear of the chamber 24 and one-way exhaust valves 56 are located high and in the front of the chamber 24 at the top of pipes which extend up from holes 84 in the base 12 and which are vented through the holes 84 in the base 12 so there is no exposure to fire/flames. This maximizes the effect of the isentropic cooling provided by the expansion of the compressed breathing air. This is also important to maintain a safe temperature inside the chamber 24 over the 4-hour designed duration. The volume of air has been designed to both maintain adequate oxygen level, maintain CO2 levels under 1% and a safe temperature level. The volume of compressed air released is controlled by a suitable regulator and appropriately sized orifice to simplify the operation of the chamber 24. The cylinders 47 on the right side of the shelter 10 has plumbing which extends from the cylinders 47 up over the door 34 and merges through a valve with the plumbing extending from the cylinders 47 on the left side to form one flow line to the rear of the shelter 10. The air flows from the cylinders 47, through the manifold 72, to a regulator 73 that controls the pressure, as shown in FIG. 5, then through an orifice to control the flow rate down the left side of the chamber 24 then under the seat 70 and is released into the atmosphere beneath the seat 70, thus displacing the air (including expelled CO2 & heated air) in the chamber 24 out the two pressure relief valves 56 near the ceiling on either side of the door 34. The pipes 50 vent the air passing through the pressure relief valves 56 to outside and underneath the shelter through holes 84 in the base, as shown in FIG. 7, that the hollow pipes 50 extend into and below the base 12. Activation is accomplished simply by opening the 7-cylinder valves. The air is released into the chamber 24 through a muffler 74 to reduce noise level. There is 2 cubic feet of released air per occupant. For six adults to be sustained safely for 4 hours, there is a release of 12 CFM of air over 4 hours. Seating for 6 occupants is provided along with food & potable water with a 10-year from date-of-manufacture shelf life.

Additional features may be included with the shelter 10. Battery powered air conditioning for additional cooling of the chamber 24. The exhaust and intake for the condenser side of the AC will vent through the floor. The internal air will be recirculated through the evaporator side of the AC unit. An example is the EcoFlow 5,100 BTU Portable Air Conditioner.

Battery backup power unit for operation of other equipment, charging phones, etc. The unit will remain on standby connected to power, in garage or other on-site location in close proximity to the shelter 10, then carried to the shelter 10 when fire danger requires the use of the shelter 10.

Emergency Position Indicating Radio Beacon (EPIRB) and GPS emergency location equipment may be stored in the chamber 24 and available for use as needed.

Remote cameras for viewing external conditions may be included in the Shelter 10. The cameras may be embedded in each of the walls and roof 22 and communicate wirelessly with a controller and display in the chamber 24. Alternatively, small metal inspection tubes that are plugged on the inside which accesses the chamber 24 to prevent path for heat/smoke ingress in each wall and roof 22, or selective locations may be used for a bore camera to extend into and through to observe the outside of the shelter 10. An example of a bore camera which could be used is the Inspection Camera, Triple Lens Teslong Borescope with 6″ IPS Split Screen, WiFi Endoscope Camera with Light IP67 Waterproof Flexible Cable Scope Camera for Automotive/Home/Wall/Pipe/Car (16.4 ft).

Remote temperature sensing system for monitor external temperatures. Sensors will be embedded in the exterior wall surface of the shelter 10 and connected to a wall hung battery powered display in the chamber 24 either by WiFi or wires extending through one or more walls and the roof 22. An example of a remote temperature sensing system is the TC0304, 4-Ch Thermocouple Thermometer K Type, USB output to PC for Datalog and monitoring, with 3 Meters K Type Mini-Connector Thermocouple Temperature Probe Sensor K Type Thermocouple Wire Temperature Sensing Line Measure.

Storage for valuables. Wall hung cabinets 80 for valuables, sundries and above identified accessories.

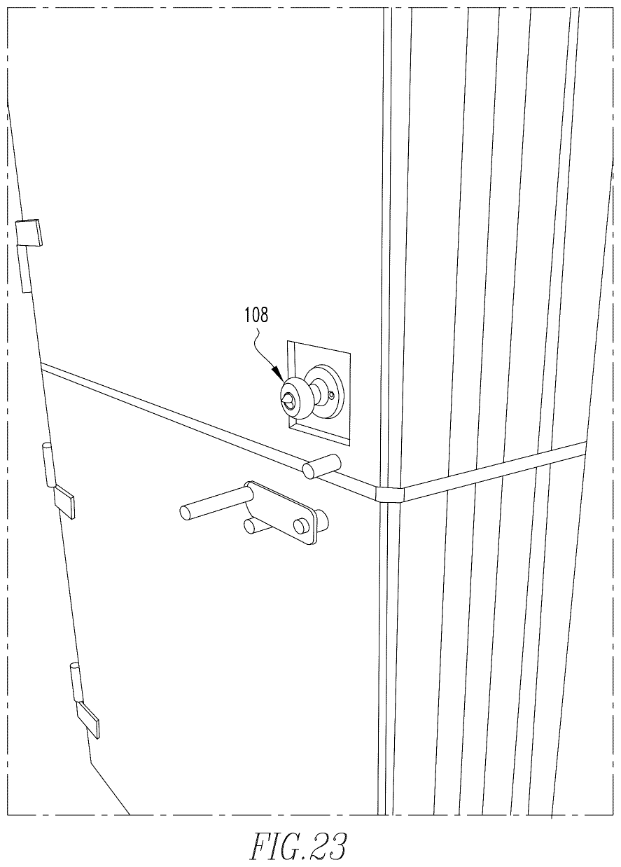

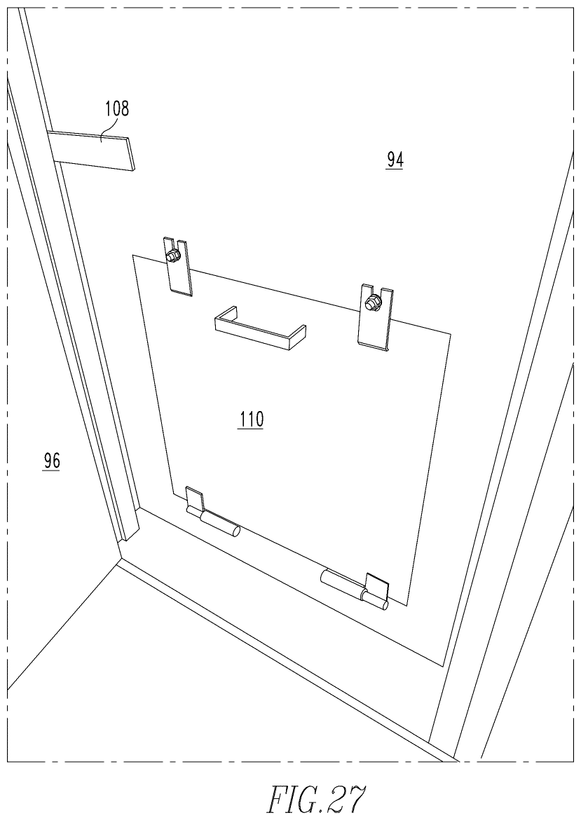

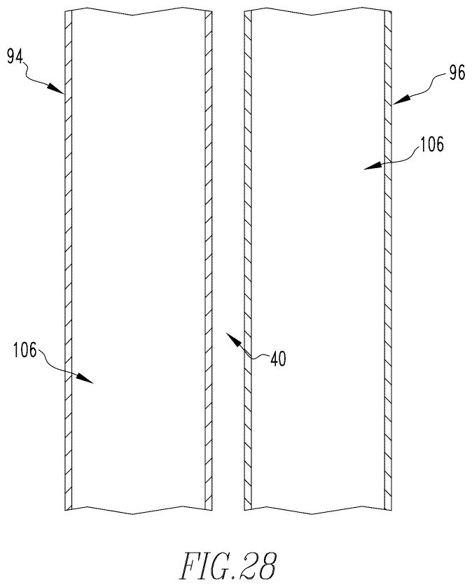

In an alternative embodiment, the present invention pertains to a shelter 10 for protecting a person from fire and heat external to the shelter 10, as shown in FIGS. 1, 2 and 14. The shelter 10 comprises a base 12, The shelter 10 comprises a front wall 14 extending up from the base 12. The shelter 10 comprises a right wall 16 extending up from the base 12 and alongside the front wall 14. The shelter 10 comprises a left wall 18 extending up from the base 12 and alongside the front wall 14. The shelter 10 comprises a rear wall 20 extending up from the base 12 and alongside the front wall 14 and the left wall 18 and opposing the right wall 16. The shelter 10 comprises a roof 22 atop the front wall 14, the right wall 16, the left wall 18 and the rear wall 20 which together define a protected chamber 24 from fire. The roof 22, the front wall 14, the right wall 16 and the left wall 18 each having a core 26 made of a three-dimensional metal matrix 28 embedded in and extending through Insulation 30 with concrete 32 positioned about the front wall 14, the right wall 16, the left wall 18, the rear wall 20 and the roof 22. The shelter 10 comprises an outer fire-resistant door 94 disposed in either the front wall 14, the right wall 16, the left wall 18 or the left wall 18 which provides access to the chamber 24, as shown in FIGS. 23-28. The outer fire-resistant door 94 containing fire- and heat-resistant insulation 30. The shelter 10 comprises an inner fire-resistant door 96 which provides access to the chamber 24. The inner fire-resistant door 96 disposed adjacent to the outer fire-resistant door 94 with an air gap disposed between the inner and the outer fire-resistant doors 96, 94. The inner fire-resistant door 96 containing fire- and heat-resistant insulation 30. The roof 22, the inner and outer doors, the front wall 14, the right wall 16, the left wall 18, the rear wall 20, the concrete 32 layer, and the base 12 protect the person in the chamber 24 from fire and heat at least in excess of 600 degrees Fahrenheit for at least 2 hours.

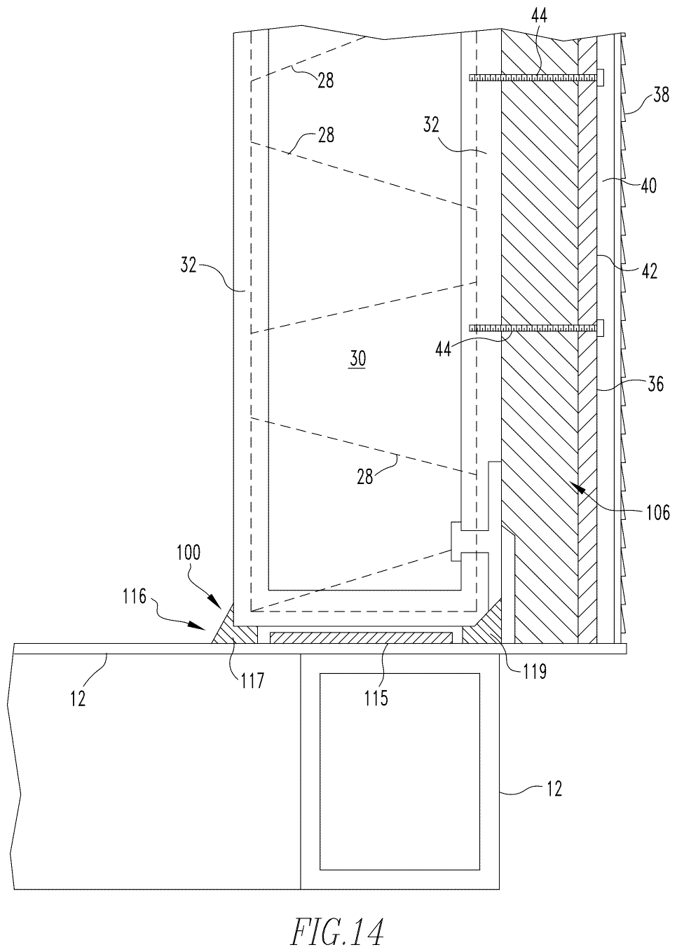

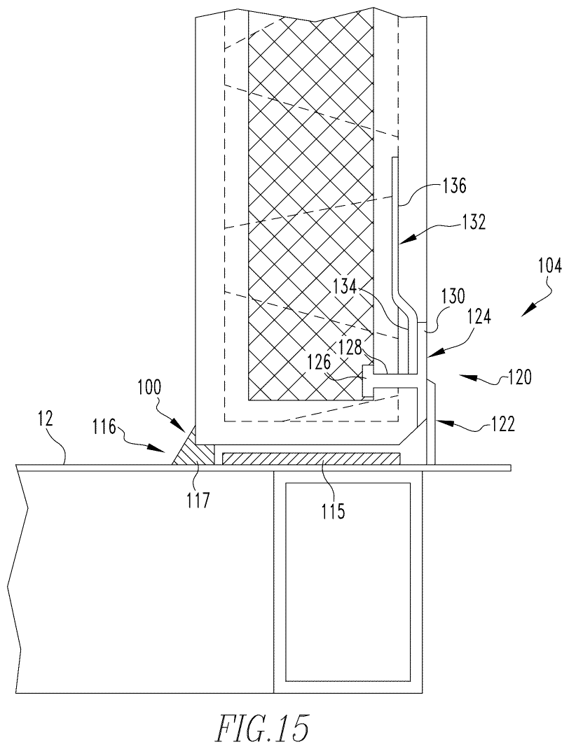

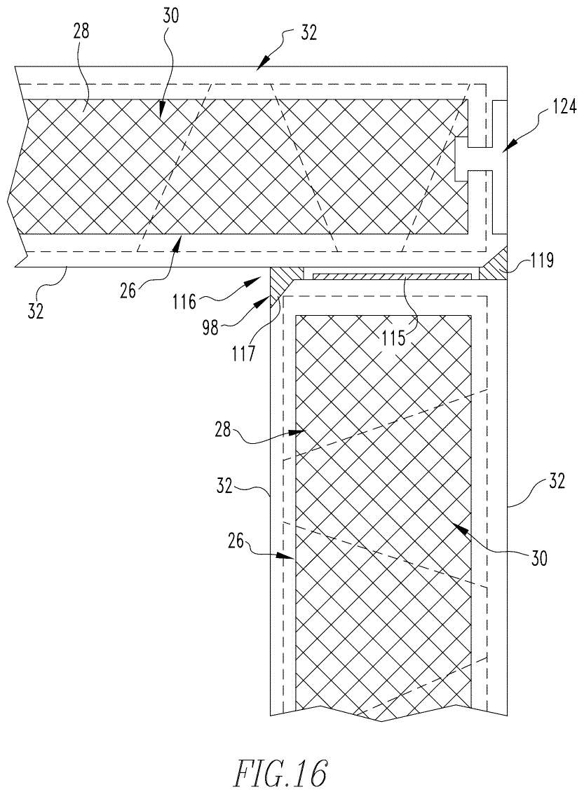

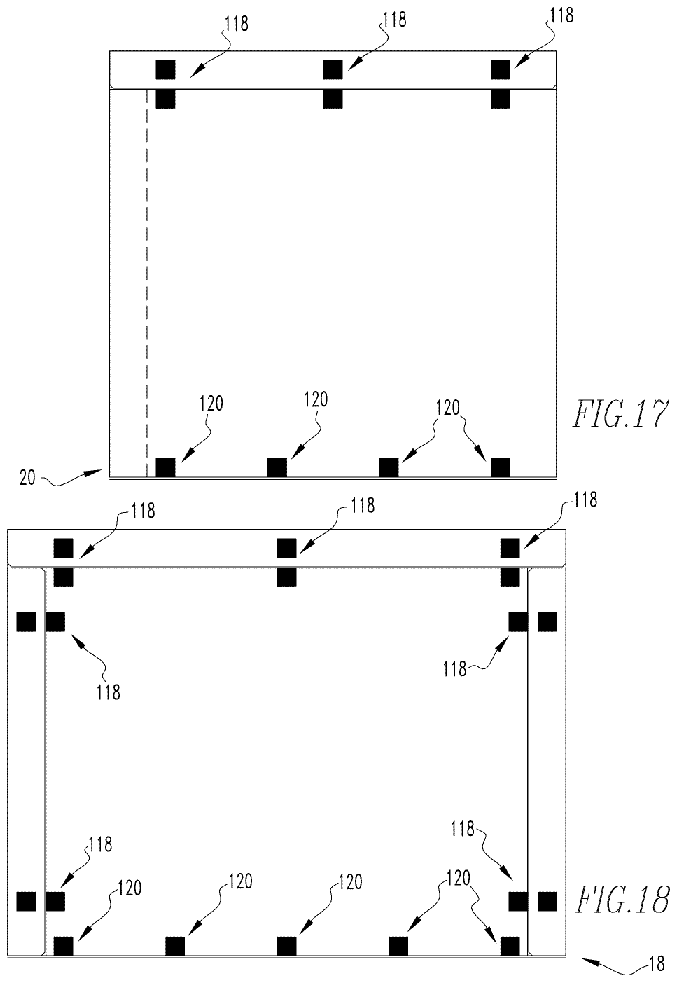

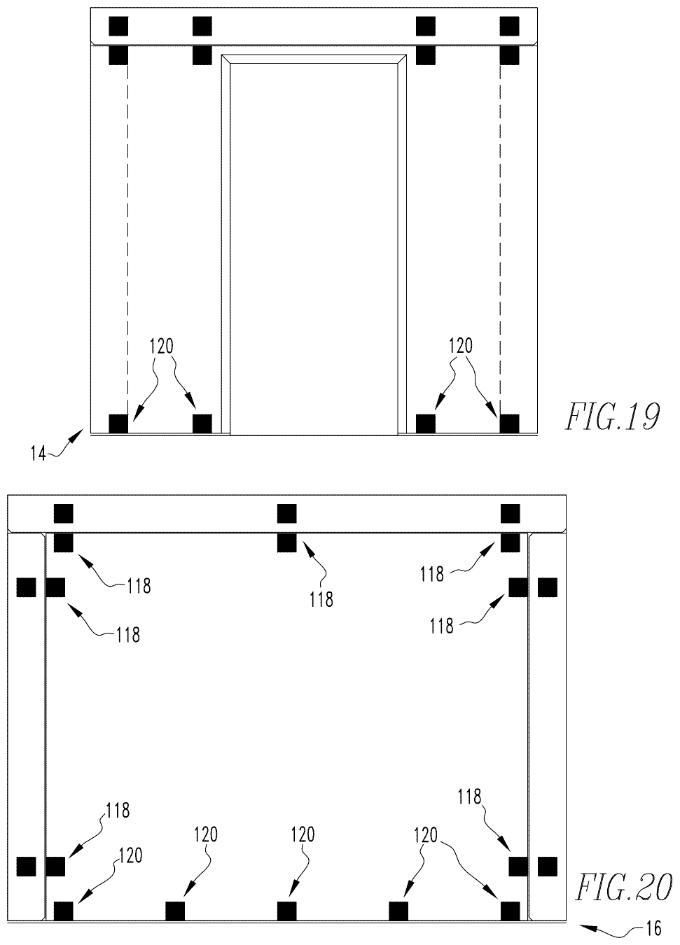

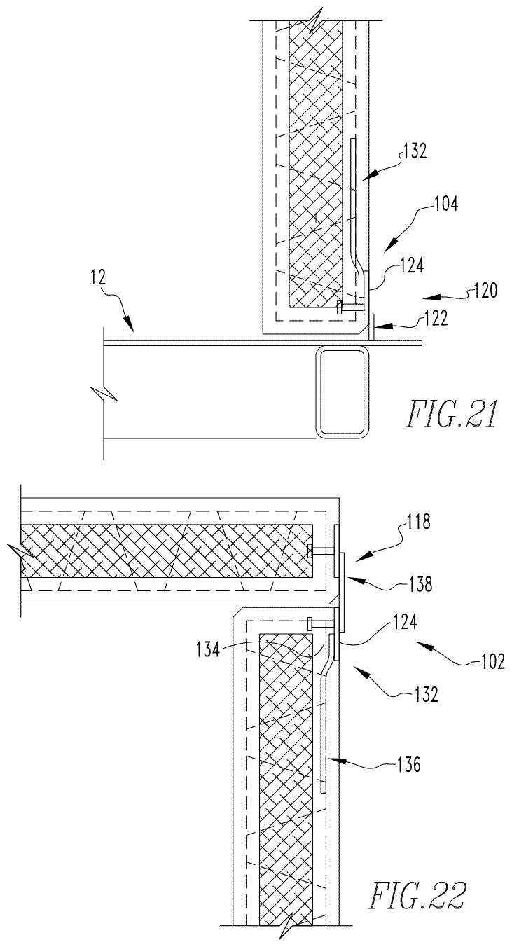

The shelter 10 may include a fire- and heat-resistant roof seal 98, as shown in FIG. 16, disposed between the roof 22 and the front wall 14, the right wall 16, the left wall 18 and the rear wall 20. The shelter 10 may include a fire- and heat-resistant base seal 100 disposed between the base 12 and the front wall, the right wall 16, the left wall 18 and the rear wall 20. The shelter 10 may include metal roof brackets 102 attached to the roof 22 and the front wall, the right wall 16, the left wall 18 and the rear wall 20 to fix the roof 22 to the front wall, the right wall 16, the left wall 18 and the rear wall 20, as shown in FIGS. 17-20. The shelter 10 may include metal base brackets 104 attached to the base 12 and the front wall, the right wall 16, the left wall 18 and the rear wall 20, to fix the base 12 to the front wall, the right wall 16, the left wall 18 and the rear wall 20. The shelter 10 may include a fire- and heat-resistant blanket layer 106 attached to the concrete 32 layer, as shown in FIG. 14, covering the front wall, the right wall 16, the left wall 18 and the rear wall 20 down to the base 12, and covering and attached to the roof 22.

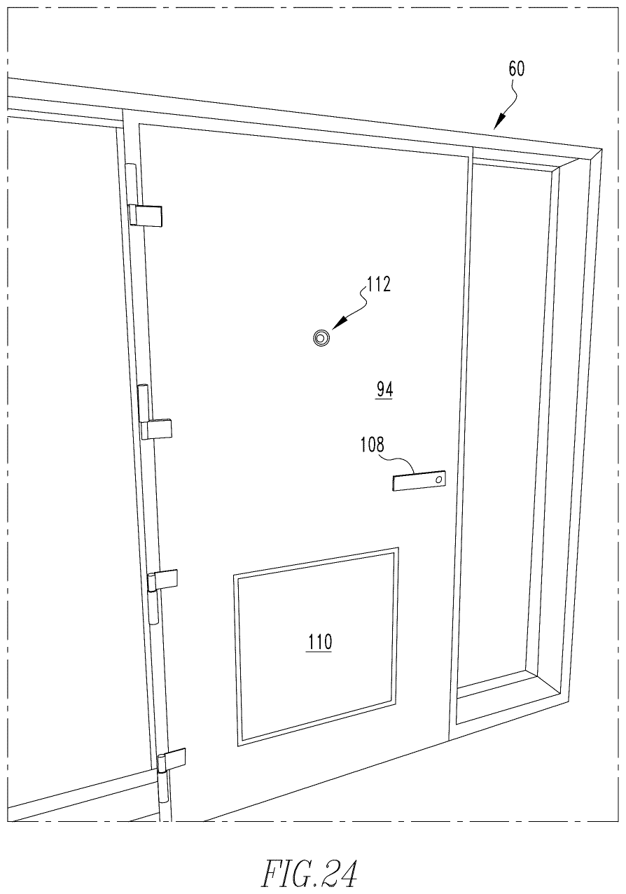

The inner door may have a door handle 108, as shown in FIG. 23, which when turned allows the inner door to open into the chamber 24. The outer door may have an escape hatch 110, as shown in FIGS. 24-27, which opens inwards into the chamber 24 through which the person is able to escape the shelter 10 even when the outer door is not opened. The outer door may have a peephole 112 and a thermometer 114, as shown in FIG. 26.

The shelter 10 may include a heat reflective layer 36 disposed on the blanket layer 106 over the front wall, right wall 16, the left wall 18, the rear wall 20 and the roof 22, as shown in FIG. 14. The shelter 10 may include an inflammable layer 38 in spaced relation to the reflective layer 36 on each of the front wall, the right wall 16, the left wall 18, and the rear wall 20 and the roof 22 forming an airgap 40 between the inflammable layer 38 and the reflective layer 36 in each of the front wall, the right wall 16, the left wall 18, the rear wall 20, and the roof 22.

The shelter 10 may include inflammable heat-resistant spacers 42 attached to and between the reflective layer 36 and the inflammable layer 38 of the front wall, the right wall 16, the left wall 18, the rear wall 20 and the roof 22 which maintain the inflammable layer 38 in spaced relation with the reflective layer 36 to define the airgap 40. The shelter 10 may include fasteners 44 extending through the inflammable layer 38, the spacers 42, the reflective layer 36, the blanket layer 106 and the front wall, the right wall 16 the left wall 18, the rear wall 20, and the roof 22 to fix the inflammable layer 38, the spacers 42, the blanket layer 106, and the reflective layer 36 in place with the front wall, the right wall 16, the left wall 18, the rear wall 20, and the roof 22.

The shelter 10 may include a cylinder storage section 46 for storing compressed air cylinders 47 to provide air to the chamber 24, as shown in FIGS. 2, 4, and 5. The shelter 10 may include plumbing 48 disposed in the chamber 24 to attach to the cylinders 47 to control air flow out of the cylinders 47 into the chamber 24. The shelter 10 may include a hollow pipe 50 extending up from the base 12, the pipe 50 having a top 52 and a bottom 54, the top 52 having a one-way exhaust valve 56 through which air from the chamber 24 enters and vents through the pipe 50 and out through the base 12, the bottom 54 of the pipe 50 attached to the base 12 and in fluidic communication to outside the base 12. The shelter 10 may include a release port 58 for the compressed air from the air cylinders 47 to flow into the chamber 24. The release port 58 in fluidic communication with the plumbing 48. The release port 58 may be disposed adjacent the base 12 and the rear wall 20, and the pipe 50 is disposed adjacent the front wall and opposing the release port 58 with the one-way exhaust valve 56 adjacent the roof 22 so isentropic cooling provided by the expansion of the compressed breathing air occurs. The inflammable layer 38 may be formed of cement board. The reflective layer 36 may be disposed on the external surface of each of the front wall, right wall 16, the left wall 18, and the rear wall 20 is one piece.

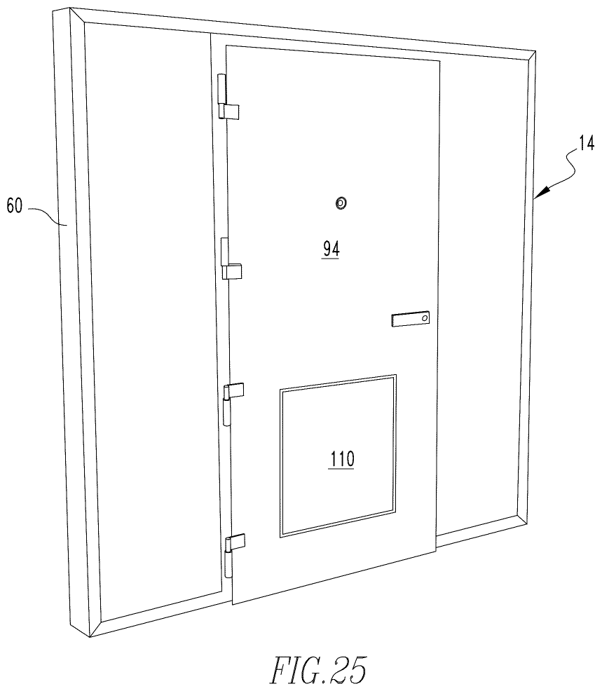

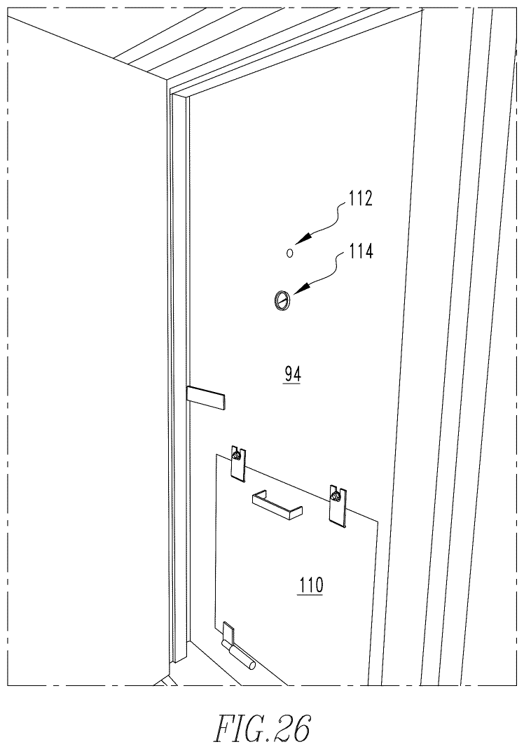

The shelter 10 may include a metal frame 60 in the front wall to which the inner door and outer door are attached, as shown in FIGS. 24 and 25. The base 12 may include a steel platform 62 with fork lift pockets 64, as shown in FIG. 14, and a lifting eye 66 at each corner for lifting the shelter 10, as shown in FIG. 1. The core 26 of each wall and the roof 22 may include an EVG panel. The concrete 32 may form a continuous one-piece concrete 32 layer enveloping the front wall, the right wall 16, the left wall 18 and the rear wall 20 down to the base 12.

The present invention pertains to a method for protecting a person from fire and heat. The method comprises the steps of closing an outer fire-resistant door 94 of a shelter 10. There is the step of closing an inner fire-resistant door 96 of the shelter 10, The shelter 10 comprises a base 12. The shelter 10 comprises a front wall extending up from the base 12. The shelter 10 comprises a right wall 16 extending up from the base 12 and alongside the front wall. The shelter 10 comprises a left wall 18 extending up from the base 12 and alongside the front wall. The shelter 10 comprises a rear wall 20 extending up from the base 12 and alongside the front wall and the left wall 18 and opposing the right wall 16. The shelter 10 comprises a roof 22 atop the front wall, the right wall 16, the left wall 18 and the rear wall 20 which together define a protected chamber 24 from fire. The roof 22, the front wall, the right wall 16 and the left wall 18 each having a core 26 made of a three-dimensional metal matrix 28 embedded in and extending through insulation 30 with concrete 32 positioned about the front wall, the right wall 16, the left wall 18, the rear wall 20 and the roof 22. The shelter 10 comprises an outer fire-resistant door 94 disposed in either the front wall, the right wall 16, the left wall 18 or the left wall 18 which provides access to the chamber 24. The outer fire-resistant door 94 containing fire- and heat-resistant insulation 30. The shelter 10 comprises an inner fire-resistant door 96 which provides access to the chamber 24. The inner fire-resistant door 96 disposed adjacent to the outer fire-resistant door 94 with an air gap disposed between the inner and the outer fire-resistant doors 96, 94. The inner fire-resistant door 96 containing fire- and heat-resistant insulation 30. The roof 22, the inner and outer doors 96, 94, the front wall, the right wall 16, the left wall 18, the rear wall 20, the concrete 32 layer, and the base 12 protect the person in the chamber 24 from fire and heat at least in excess of 600 degrees Fahrenheit for at least 2 hours. There is the step of opening valves of compressed air cylinders 47 in the shelter 10 to flow the compressed air from the cylinders 47 into the chamber 24 of the shelter 10.

The present invention pertains to a method for building a shelter 10 for protecting a person from fire and heat external to the shelter 10. The method comprises the steps of placing a front wall on a base 12 so the front wall is extending up from the base 12. There is the step of placing a right wall 16 on a base 12 so the right wall 16 is extending up from the base 12 and alongside the front wall. There is the step of placing a left wall 18 on a base 12 so the left wall 18 is extending up from the base 12 and alongside the front wall. There is the step of placing a rear wall 20 on a base 12 so the rear wall 20 is extending up from the base 12 and alongside the front wall and the left wall 18 and opposing the right wall 16. There is the step of placing a roof 22 atop the front wall, the right wall 16, the left wall 18 and the rear wall 20 which together define a protected chamber 24 from fire. The roof 22, the front wall, the right wall 16 and the left wall 18 each having a core 26 made of a three-dimensional metal matrix 28 embedded in insulation 30 with concrete 32 positioned about the front wall, the right wall 16, the left wall 18, the rear wall 20 and the roof 22. There is the step of fixing an outer fire-resistant door 94 in either the front wall, the right wall 16, the left wall 18 or the left wall 18 which provides access to the chamber 24. The outer fire-resistant door 94 containing fire- and heat-resistant insulation 30. There is the step of fixing an inner fire-resistant door 96 which provides access to the chamber 24 adjacent to the outer fire-resistant door 94 with an air gap disposed between the inner and the outer fire-resistant doors 96, 94. The inner fire-resistant door 94 containing fire- and heat-resistant insulation 30. The roof 22, the inner and outer doors 96, 94, the front wall, the right wall 16, the left wall 18, the rear wall 20, the concrete 32 layer, and the base 12 protect the person in the chamber 24 from fire and heat at least in excess of 600 degrees Fahrenheit for at least 2 hours. There may be the step of attaching a fire- and heat-resistant blanket layer 106 to the concrete 32 layer on the front wall, the right wall 16, the left wall 18 and the rear wall 20 down to the base 12, and to the concrete 32 layer on the roof 22.

In an alternative embodiment, the first, second, third, and fourth walls and the roof 22 have a ceramic fiber blanket layer 106 disposed directly on their external concrete 32 surfaces, instead of the heat reflective layer, with the heat reflective layer disposed directly on the external surface of the ceramic fiber blanket layer 106, with the remainder of the structure described above being the same. See FIG. 14. The ceramic fiber blanket layer 106 may be of the type sold by Ceramaterials, 525 Silver Lake Rd., Pennsylvania, 18328. In another embodiment, there may be a ceramic fiber blanket layer 106 but no heat reflective layer, with the remainder of the structure described above being the same.

The ceramic fiber blanket layer 106 may be applied in several different ways. The purpose of its placement is to effectively envelope the walls and roof 22 with the ceramic fiber blanket layer 106. The ceramic fiber blanket layer 106 may be cut to length and height to match the length and width of each wall and the roof 22 to which they are attached. Alternatively, the ceramic fiber blanket layer 106 may be wrapped continuously about the first, second, third, and fourth walls and attached to them; with the ceramic fiber blanket layer 106 cut to length and height of the roof 22 and separately attached to the roof 22. Alternatively, the ceramic fiber blanket layer 106 may be extended continuously from the base 12 of the left side, up over the roof 22 and down to the base 12 of the right side, with the ceramic fiber blanket layer 106 cut to length and height of the front and back walls. In each instance of the attachment of the ceramic fiber blanket layer 106 to the walls and roof 22, the wall with the doors 34 has the ceramic fiber blanket layer 106 cut out to have an opening which matches the perimeter of the outer door.

In yet another embodiment, the continuous one-piece concrete 32 layer enveloping the roof 22, the front wall, the right wall 16, the left wall 18 and the rear wall 20 down to the base 12 may only be a continuous one-piece concrete 32 layer enveloping the front wall, the right wall 16, the left wall 18 and the rear wall 20 down to the base 12, but not the roof 22. Instead, the roof 22 is attached to the top 52 of the front, right, left and rear wall 20 by roof brackets 102. In still another embodiment, there is no continuous one-piece concrete 32 layer enveloping the walls, but instead each of the walls are separately prefabricated and attached to the base 12 with base brackets 104. The roof 22 is then attached to the four walls with roof brackets 102.

The roof seal 98 and the base seal 100 serve to further ensure heat and smoke is precluded from entering the chamber 24 through the joints 116 formed between the roof 22 and the top 52 of each wall and the base 12 and the bottom 54 of each wall. As shown in FIGS. 15 and 16 both the roof seal 98 and the base seal 100 are preferably comprised of fire block/smoke caulking disposed on the inside of each joint 116 extending from the inside surface of each wall of about 1 inch to 3 inches into the joint 116. An intumescent joint strip 115 extends from the fire block/smoke caulking 117 to the opposite side of the joint 116 up to intumescent silicone caulk 119 disposed at the outside of each joint 116. The intumescent silicone caulk 119 extends from the outer surface of each wall about 1 inch to about 3 inches into the joint 116.

Welds are used to fixedly attach the walls to the base 12 with base brackets 104 and the roof 22 to the walls with roof brackets 102. FIGS. 17-20 show the weld positions between the walls and the base 12 and the walls and the roof 22. There are two types of welds, upper welds 118 and lower welds 120. Lower welds 120 are used to fixedly attach the walls to the base 12. FIGS. 15 and 22 show a cross-section of a lower weld 120. The lower weld 120 comprises a base flange 122 of the base plate that extends vertically upwards from the base plate. The lower weld 120 comprises an H anchor 124 having a lower tab 126, a stem 128 extending from the lower tab 126 and an upper tab 130 attached to the other side of the stem 128 and in spaced relation to the lower tab 126, together forming an H type shape. The lower tab 126 is welded to the metal matrix 28 in the wall, with the stem 128 extending outwards and the upper tab 130 positioned to align with the outer concrete surface of the wall. The lower weld 120 is comprised of a somewhat S shaped tab 132. A first portion 134 of the S shaped tab 132 is welded to the upper tab 130 and a second portion 136 of the S shaped tab 132 extends essentially in parallel with the metal matrix 28 in a height wise direction. When each wall is formed, the H anchor 124 and the S shaped tab 132 are already attached and in position relative to the metal matrix 28. When the concrete 32 is poured to form the wall, the concrete 32 engulfs the metal matrix 28 along with the H anchor 124 and the S-shaped tab, except the outer surface of the upper tab 130 is exposed because the concrete 32 fills to about the height of the surface of the upper tab 130 relative to the metal matrix 28. When the wall is positioned on the joint strip on the base 12, the upper tab 130 is disposed adjacent the base flange 122 so the base flange 122 and the upper tab 130 are easily able to be welded together. The H anchor 124 and the S shaped tab 132 by being encased in the concrete when it hardens together serve to provide a secure and stable anchor to which the base flange 122 can be welded. Each lower weld 120 of each wall to the base 12 is formed in this way.

The upper weld 118 is used to fixedly attach walls together and walls to the roof 22. The upper weld 118 is formed in a similar way as the lower weld 120, except instead of the base flange 122, there is a connection plate 138 which is used to fixedly attach a wall to another wall or a wall to the roof 22. See FIG. 22. The upper weld 118 comprises an H anchor 124 having a lower tab 126, a stem 128 extending from the lower tab 126 and an upper tab 130 attached to the other side of the stem 128 and in spaced relation to the lower tab 126, together forming an H type shape. The lower tab 126 is welded to the metal matrix 28 in the wall, with the stem 128 extending outwards and the upper tab 130 positioned to align with the outer concrete surface of the wall. The upper weld 118 is comprised of a somewhat S shaped tab 132. A first portion 134 of the S shaped tab 132 is welded to the upper tab 130 and a second portion 136 of the S shaped tab 132 extends essentially in parallel with the metal matrix 28 in a longitudinal direction. When each wall is formed, the H anchor 124 and the S shaped tab 132 are already attached and in position relative to the metal matrix 28. When the concrete 32 is poured to form the wall, the concrete 32 engulfs the metal matrix 28 along with the H anchor 124 and the S-shaped tab, except the outer surface of the upper tab 130 is exposed because the concrete 32 fills to about the height of the surface of the upper tab 130 relative to the metal matrix 28. When the wall is positioned on the base 12, the upper tab 130 is disposed adjacent the upper tab 130 of the roof 22 or the adjacent wall, so the adjacent upper tabs 130 are easily able to be welded together with the connection plate 138 welded to the adjacent upper tabs 130. The H anchor 124 and the S shaped tab 132 by being encased in the concrete when it hardens together serve to provide a secure and stable anchor to which the connection plate 138 can be welded. At each upper weld 118 location between the top 52 of the wall and the roof 22, the roof 22 has just an H anchor 124 attached to the metal matrix 28 of the roof 22, as described above, to which one end of the connection plate 138 is welded. Each upper weld 118 of each wall to the roof 22 is formed in this way. Similarly, at the location of each upper weld 118 between adjacent walls, one of the walls only has an H anchor 124 attached to the metal matrix 28 of it, as described above, to which one end of the connection plate 138 is welded, while the other wall has the S-shaped tab and the H anchor 124 to which the other end of the connection plate 138 is welded.

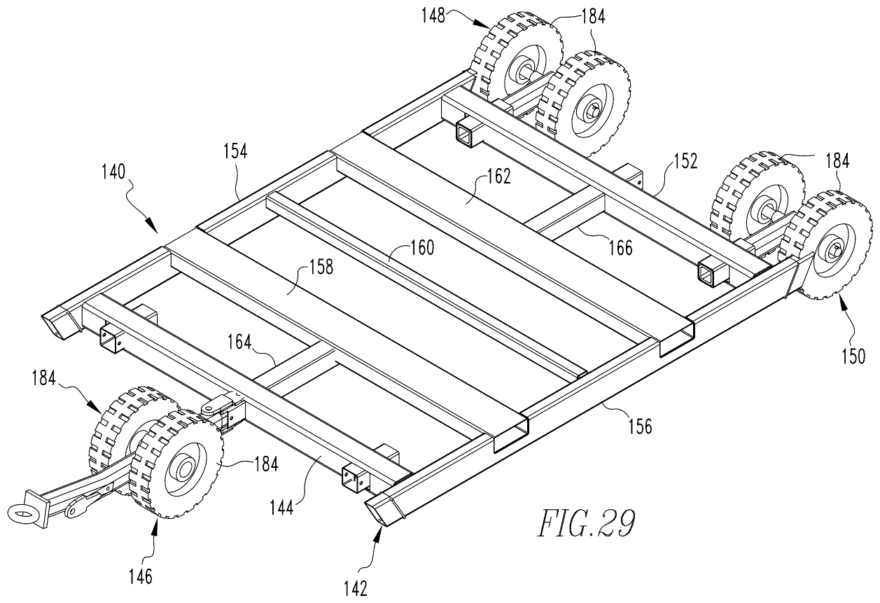

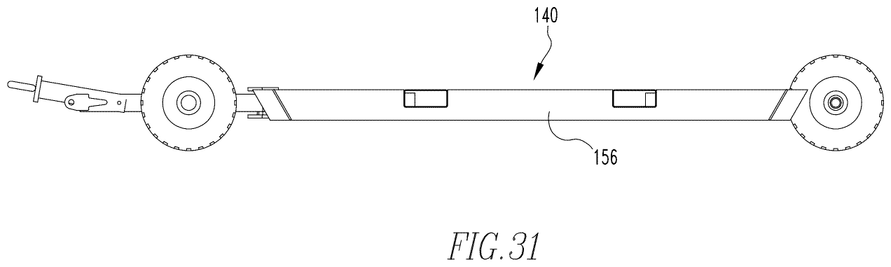

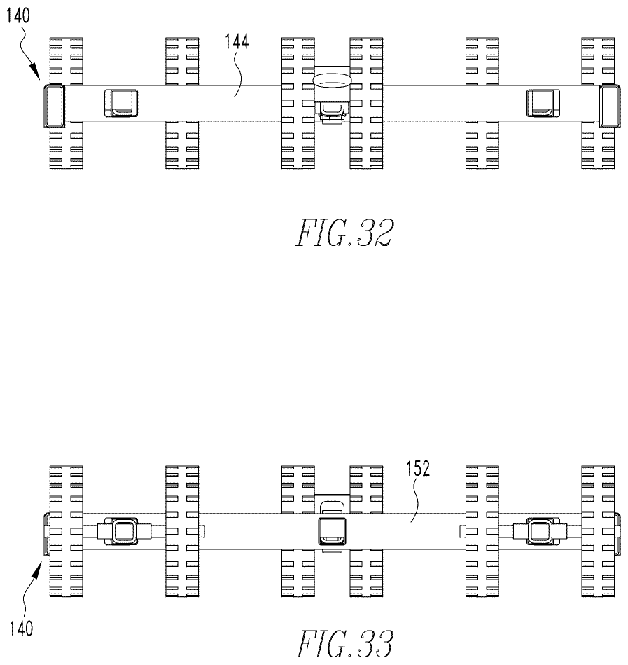

To transport the shelter 10, a dolly 140 may be used. FIGS. 29-33 show a dolly 140 which may be attached to a hitch of a vehicle, such as a truck. The dolly 140 has a skeleton 142 upon which the shelter 10 is disposed during transport. Extending outwards from the middle of a front end 144 of the dolly 140 is a front wheel assembly 146. The front wheel assembly 146 is rotatably attached to the dolly 140 so it is able to rotate horizontally in an arc with respect to a horizontal plane of the skeleton 142. The dolly 140 has first rear wheel assembly 148 and a second rear wheel assembly 150 which are both attached to a rear end 152 of the dolly 140. It is upon the front wheel assembly 146 and the first and second rear wheel assemblies that the skeleton 142 holding the shelter 10 is able to roll when towed by a vehicle.

The skeleton 142 has a right side 154 attached to the front and rear end, and a left side 156 attached to the front and rear end and in spaced relation with the front end 144. The front and rear ends and the left side and right sides essentially form a rectangular shape. At least a first cross bar 158, a second cross bar 160, and a third cross bar 162 are attached perpendicularly to the left and right sides and in parallel and spaced relation with each other and with the front and rear ends. There may be a first strut 164 extending between and attached to the front end 144 and the first cross bar 158, and at least a second strut 166 extending between and attached to the rear end 152 and the third cross bar 162. The first and second struts provide structural support to the skeleton 142 so the dolly 140 is able to support between 15,000 pounds and 20,000 pounds, and preferably 16,000 pounds.

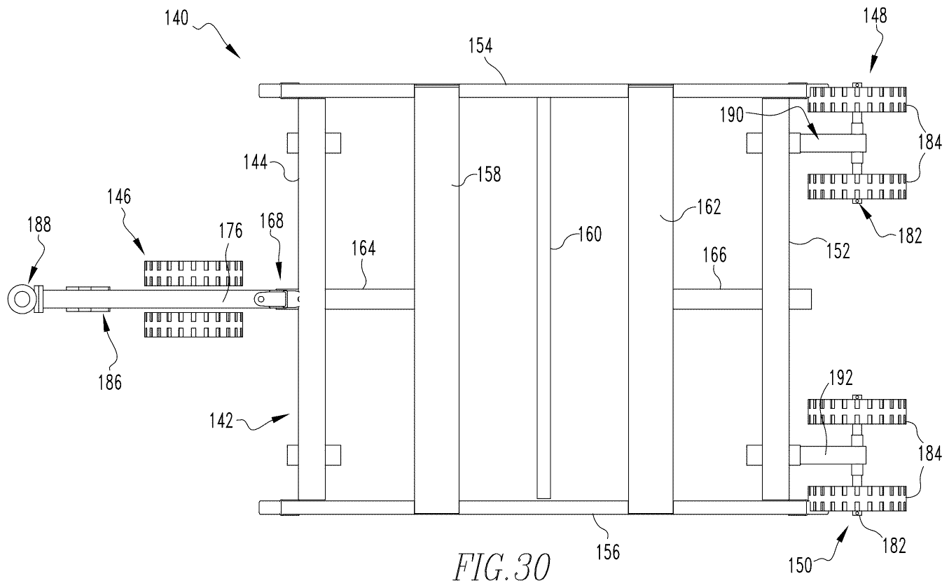

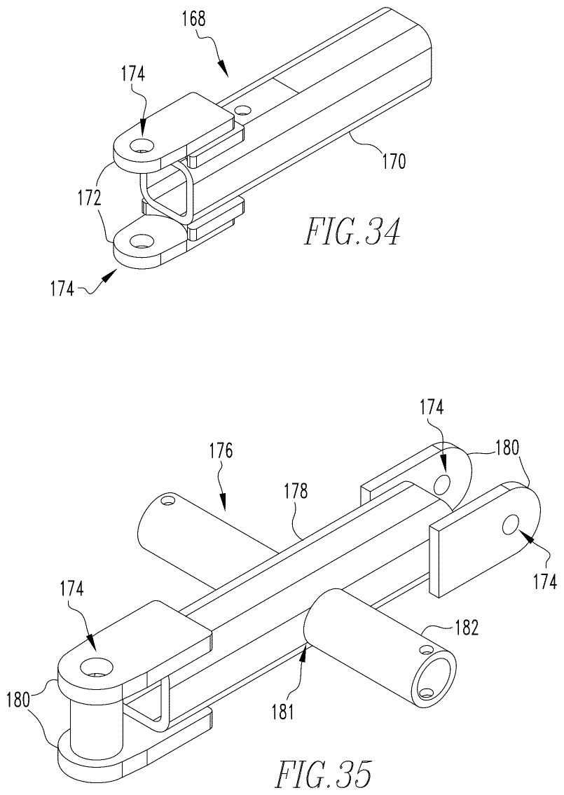

As shown in FIGS. 30 and 34, there is a linkage 168 having front post 170 extending perpendicularly outward from the front end 144. The front post 170 has opposing linkage plates 172, each with a hole 174 in alignment.

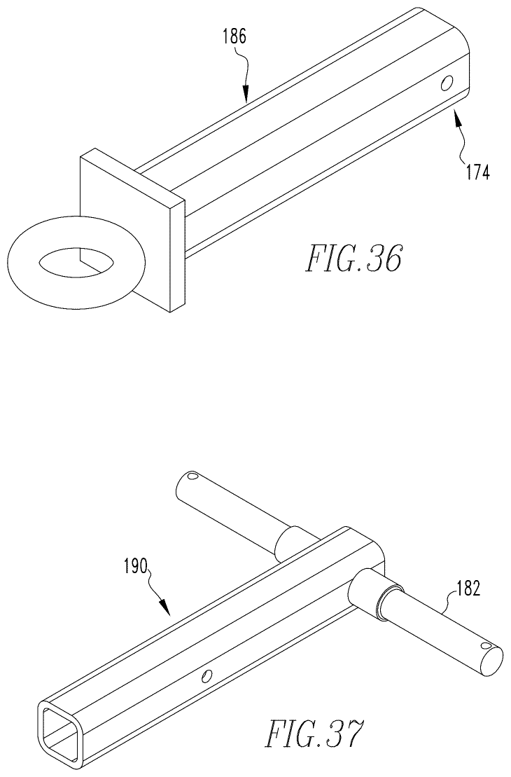

The front wheel assembly 146 includes a front mount 176 having a tube 178 with a first set of opposing lips 180 at a first end of the tube 178, as shown in FIG. 35. The opposing lips 180 each have a hole 174 in alignment for a pin to be vertically inserted through them and through the hole 174 in the linkage 168 to rotatably attach the front wheel assembly 146 to the linkage 168 at the front end 144 of the skeleton 142 with respect to its horizontal plane. The tube 178 has an opening 181 through which an axle 182 horizontally extends. On each side of the axle 182 a wheel 184 is rotatably attached. At a second end of the tube 178, there is a second set of opposing lips 180, each of which has a hole 174 in alignment for a second pin to be horizontally inserted to rotatably attach a towing bar 186 with respect to the vertical direction. The towing bar 186 has a hole 174 at one end through which the second pin also extends when it extends through the second set of lips 180 to rotatably attach the towing bar 186 to the tube 178. The towing bar 178 has an eye 188 at the other end, as shown in FIG. 36, to engage with a hitch on the vehicle that is towing the dolly 140 with the shelter 10.

On the rear end of the skeleton 142 near the right side 154 is a first post 190 which extends perpendicularly outwards. An axle 182 extends perpendicularly through the first post 190 as shown in FIG. 37, with a wheel 184 rotatably attached on each side of the first post 190, as shown in FIG. 30. Similarly, on the rear end of the skeleton 142 near the left side 156 is a second post 192 which extends perpendicularly outwards. An axle 182 extends perpendicularly through the second post 192 with a wheel 184 rotatably attached on each side of the second post 192.

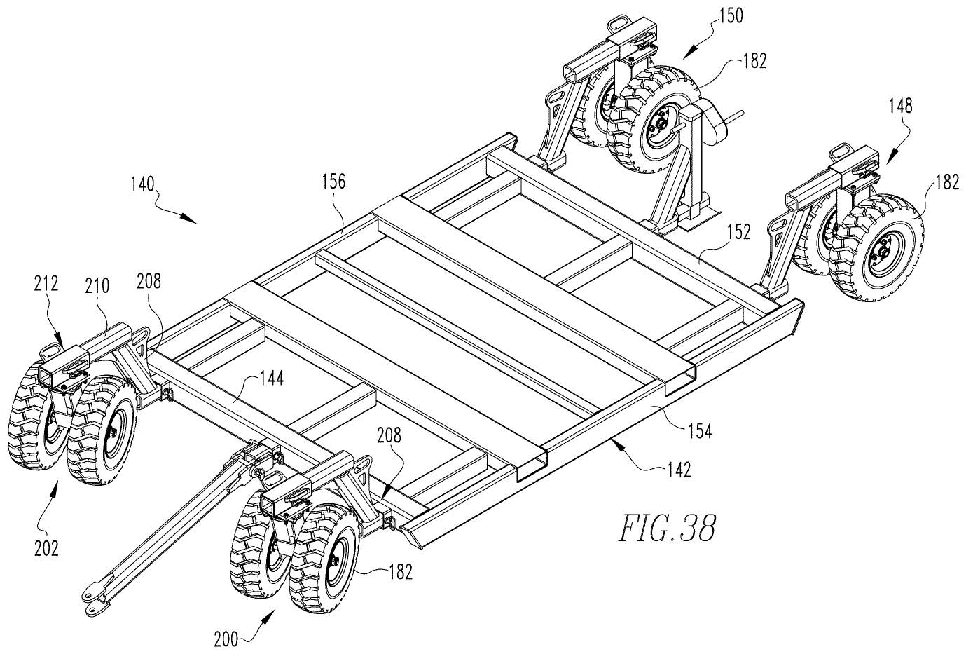

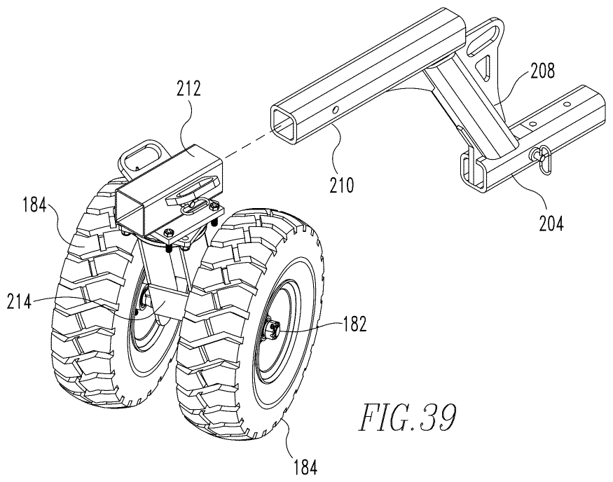

In a second embodiment of the dolly 140, as shown in FIGS. 38 and 39, there is a first front wheel assembly 200 attached to the front end 144 of the dolly 140 adjacent the right side 154 of the dolly 140, and a second front wheel assembly 202 attached to the front end 144 of the dolly 140 adjacent the left side 156 of the dolly 140. The first front wheel assembly 200 has a front bottom post 204 which fits in and extends through a first bracket 206 opening in the front end 144 of the dolly 140. A pin may be inserted through the first bracket 206 and the front bottom post 204 to secure the front bottom post 204 to the dolly 140. Extending at an angle upwards of between 30° and 90° from the front bottom post 204 and attached thereto is a front stem 208. Attached adjacent the top of the front stem 208 is a front top post 210 extending outward. The front of the front top post 210 fits into a second bracket 212 opening. A pin may be used to extend through the front top post 210 and the second bracket 212 to fix them together.

Extending downward from the second bracket 212 is a third stem 214 which has an axle 182 extending perpendicularly through it. A wheel 184 is rotatably attached to the axle 182 on each side of the third stem 214. The second front wheel assembly 202 is attached to the front end 144 of the dolly 140 in the same fashion. The first rear wheel assembly 148 and the second rear wheel assembly 150 are attached to the rear end 152 adjacent the right side 142 and the left side 156 of the dolly 140 in the same fashion as the first front wheel assembly 200. The height of the second bracket 212 of each wheel assembly of the dolly 140 is above the height of the wheels 184 from the ground so the wheels 184 are able to freely rotate.

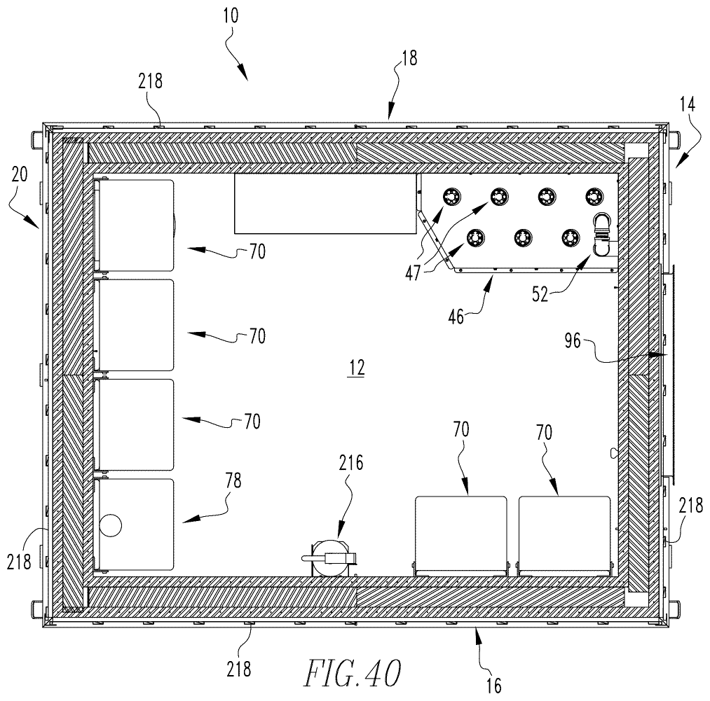

FIG. 40 is an overhead view of the shelter 10 with an alternate internal design with the roof 22 removed. There are three chairs 70 and a toilet 78 against the rear wall 20 facing the inner door 96, there are two chairs 70 against the right side wall 16 with a fire extinguisher 216 alongside, and there is a bank of pressurized air or oxygen cylinders 47 against the left side wall 18 with the necessary piping 52 in a cylinder bracket 46.

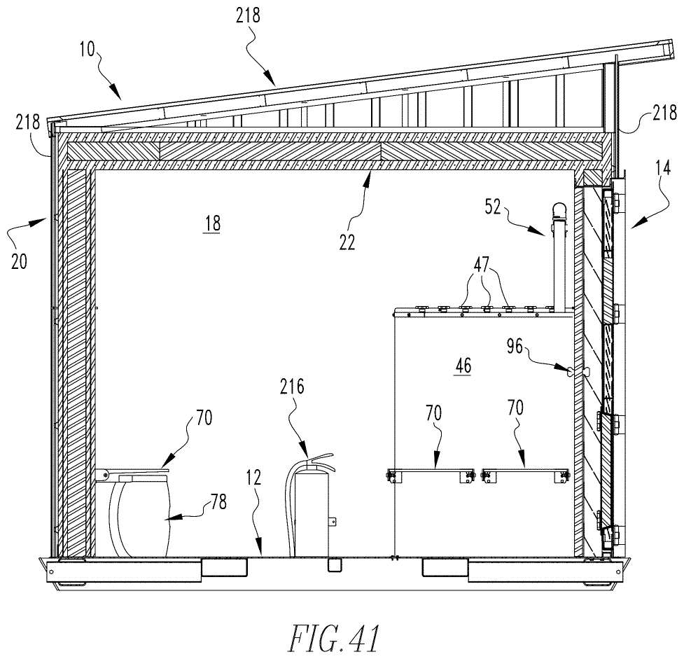

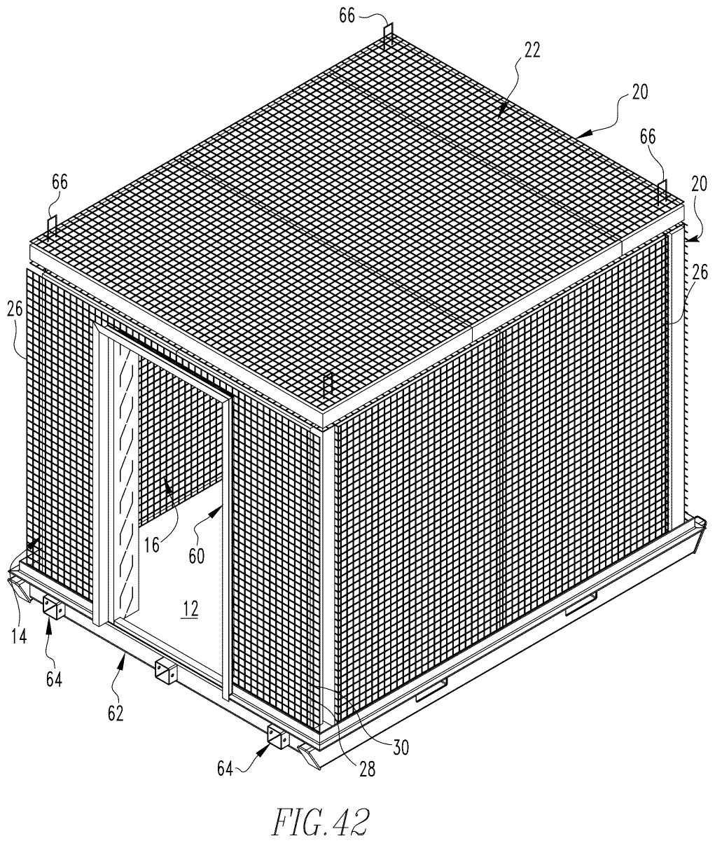

FIG. 41 is a side view of the shelter 10 with the alternate internal design with the right side wall 16 removed. The three chairs 70 and the toilet 78 against the rear wall 20, the fire extinguisher 216 and the two chairs 70 adjacent the right side wall 16, and the bank of pressurized air or oxygen cylinders 47 against the left side wall 18 are shown. Note, siding 218 is shown positioned over the roof 22 and the front and rear walls. The siding 218 may be disposed on or attached to the walls and extending up over the walls and roof 22 to provide the necessary support structure for the siding 218 over the roof 22.

FIG. 42 is a perspective view of the base 12, walls and roof 22 with their cores 26 exposed in an alternative embodiment. In this alternative embodiment, there are four lifting eyes 66 positioned at the four corners of the roof 22 to provide for cords or ropes to lift the shelter 10. On the base 12, there are three fork pockets 64 which are adapted to receive a forklift for moving the shelter 10.

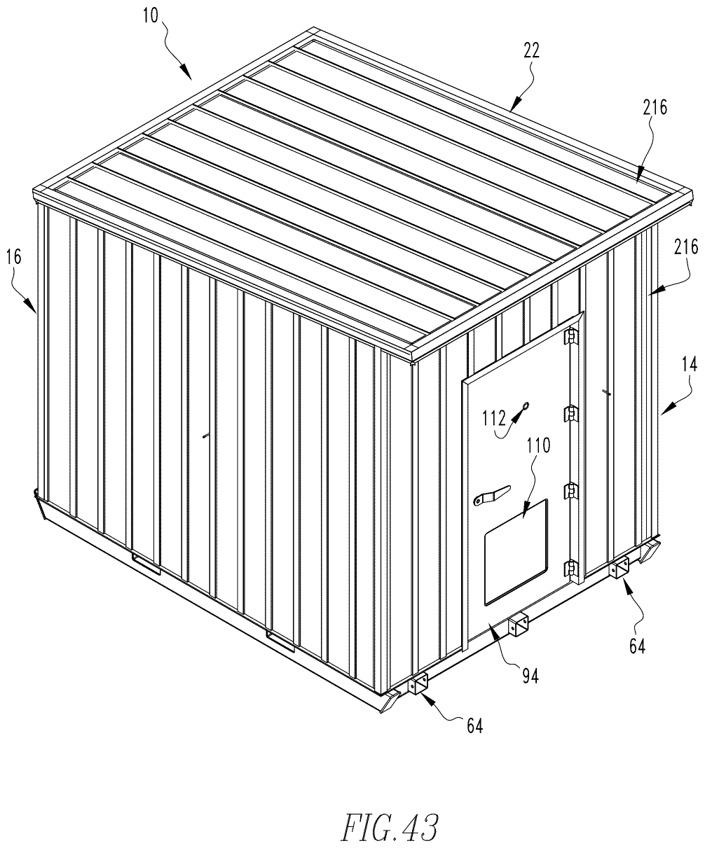

FIG. 43 is a perspective view of the shelter 10 of the alternative embodiment. Here, siding 216 has been positioned on the walls and on the roof 22, which covers over the lifting eyes so they are not seen. Typically, the siding 216 would be put into place after the shelter 10 has been situated in a desired location.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

1. A shelter for protecting a person from fire and heat external to the shelter comprising:
a base;
a front wall extending up from the base;
a right wall extending up from the base and alongside the front wall;
a left wall extending up from the base and alongside the front wall;
a rear wall extending up from the base and alongside the front wall and the left wall and opposing the right wall;
a roof atop the front wall, the right wall, the left wall and the rear wall which together define a protected chamber from fire; the roof, the front wall, the right wall and the left wall each having a core made of a three dimensional metal matrix embedded in and extending through insulation with concrete positioned about the front wall, the right wall, the left wall, the rear wall and the roof;
an outer fire-resistant door disposed in either the front wall, the right wall, the left wall or the left wall which provides access to the chamber, the outer fire-resistant door containing fire- and heat-resistant insulation; and
an inner fire-resistant door which provides access to the chamber, the inner fire-resistant door disposed adjacent to the outer fire-resistant door with an air gap disposed between the inner and the outer fire-resistant doors, the inner fire-resistant door containing fire- and heat-resistant insulation, the roof, the inner and outer doors, the front wall, the right wall, the left wall, the rear wall, the concrete layer, and the base protect the person in the chamber from fire and heat at least in excess of 600 degrees Fahrenheit for at least 2 hours.

2. The shelter of claim 1 including a fire- and heat-resistant roof seal disposed between the roof and the front wall, the right wall, the left wall and the rear wall.

3. The shelter of claim 2 including a fire- and heat-resistant base seal disposed between the base and the front wall, the right wall, the left wall and the rear wall.

4. The shelter of claim 3 including metal roof brackets attached to the roof and the front wall, the right wall, the left wall and the rear wall to fix the roof to the front wall, the right wall, the left wall and the rear wall; and metal base brackets attached to the base and the front wall, the right wall, the left wall and the rear wall, to fix the base to the front wall, the right wall, the left wall and the rear wall.

5. The shelter of claim 4 including a fire- and heat-resistant blanket layer and attached to the concrete layer enveloping the front wall, the right wall, the left wall and the rear wall down to the base, and covering and attached to the roof.

6. The shelter of claim 5 wherein the inner door has a door handle which when turned allows the inner door to open into the chamber, and wherein the outer door has an escape which opens inwards into the chamber through which the person is able to escape the shelter even when the outer door is not opened.

7. The shelter of claim 6 wherein the outer door has a peephole and a thermometer.

8. The shelter of claim 7 including a heat reflective layer disposed on the blanket layer over the front wall, right wall, the left wall, the rear wall and the roof.

9. The shelter of claim 8 including an inflammable layer in spaced relation to the reflective layer on each of the front wall, the right wall, the left wall, and the rear wall and the roof forming an airgap between the inflammable layer and the reflective layer in each of the front wall, the right wall, the left wall, the rear wall, and the roof.

10. The shelter of claim 9 including inflammable heat resistant spacers attached to and between the reflective layer and the inflammable layer of the front wall, the right wall, the left wall, the rear wall and the roof which maintain the inflammable layer in spaced relation with the reflective layer to define the airgap; and fasteners extending through the inflammable layer, the spacers, the reflective layer, the blanket layer and the front wall, the right wall the left wall, the rear wall, and the roof to fix the inflammable layer, the spacers, the blanket layer, and the reflective layer in place with the front wall, the right wall, the left wall, the rear wall, and the roof.

11. The shelter of claim 10 including a cylinder storage section for storing compressed air cylinders to provide air to the chamber.

12. The shelter of claim 11 including plumbing disposed in the chamber to attach to the cylinders to control air flow out of the cylinders into the chamber.

13. The shelter of claim 12 including a hollow pipe extending up from the base, the pipe having a top and a bottom, the top having a one-way exhaust valve through which air from the chamber enters and vents through the pipe and out through the base, the bottom of the pipe attached to the base and in fluidic communication to outside the base.

14. The shelter of claim 13 including a release port for the compressed air from the air cylinders to flow into the chamber, the release port in fluidic communication with the plumbing.

15. The shelter of claim 14 wherein the release port is disposed adjacent the base and the rear wall, and the pipe is disposed adjacent the front wall and opposing the release port with the one-way exhaust valve adjacent the roof so isentropic cooling provided by the expansion of the compressed breathing air occurs.

16. The shelter of claim 15 wherein the inflammable layer is formed of cement board.

17. The shelter of claim 16 wherein the reflective layer disposed on the external surface of each of the front wall, right wall, the left wall, and the rear wall is one piece.

18. The shelter of claim 17 including a metal frame in the front wall to which the inner door and outer door are attached.

19. The shelter of claim 18 wherein the base includes a steel platform with fork lift pockets and a lifting eye at each corner for lifting the shelter.

20. The shelter of claim 19 wherein the core of each wall and the roof includes an EVG panel.

21. The shelter of claim 20 including a dolly on which the shelter is placed to transport the shelter, the dolly adapted to engage with a vehicle for the vehicle to tow the shelter on the dolly.

22. The shelter of claim 21 wherein the concrete forms a continuous one-piece concrete layer enveloping the front wall, the right wall, the left wall and the rear wall down to the base.

23. A method for protecting a person from fire and heat comprising the steps of:
closing an outer fire-resistant door of a shelter;
closing an inner fire-resistant door of the shelter, the shelter comprising:
a base;
a front wall extending up from the base;
a right wall extending up from the base and alongside the front wall;
a left wall extending up from the base and alongside the front wall;
a rear wall extending up from the base and alongside the front wall and the left wall and opposing the right wall;
a roof atop the front wall, the right wall, the left wall and the rear wall which together define a protected chamber from fire; the roof, the front wall, the right wall and the left wall each having a core made of a three-dimensional metal matrix embedded in and extending through insulation with concrete positioned about the front wall, the right wall, the left wall, the rear wall and the roof;
the outer fire-resistant door disposed in either the front wall, the right wall, the left wall or the left wall which provides access to the chamber, the outer fire-resistant door containing fire- and heat-resistant insulation; and
the inner fire-resistant door which provides access to the chamber, the inner fire-resistant door disposed adjacent to the outer fire-resistant door with an air gap disposed between the inner and the outer fire-resistant doors, the inner fire-resistant door containing fire- and heat-resistant insulation, the roof, the inner and outer doors, the front wall, the right wall, the left wall, the rear wall, the concrete layer, and the base protect the person in the chamber from fire and heat at least in excess of 600 degrees Fahrenheit for at least 2 hours; and
opening valves of compressed air cylinders in the shelter to flow the compressed air from the cylinders into the chamber of the shelter.

24. A method for building a shelter for protecting a person from fire and heat external to the shelter comprising the steps of:
placing a front wall on a base so the front wall is extending up from the base;
placing a right wall on a base so the right wall is extending up from the base and alongside the front wall;
placing a left wall on a base so the left wall is extending up from the base and alongside the front wall;
placing a rear wall on a base so the rear wall is extending up from the base and alongside the front wall and the left wall and opposing the right wall;
placing a roof atop the front wall, the right wall, the left wall and the rear wall which together define a protected chamber from fire; the roof, the front wall, the right wall and the left wall each having a core made of a three-dimensional metal matrix embedded in insulation with concrete positioned about the front wall, the right wall, the left wall, the rear wall and the roof;
fixing an outer fire-resistant door in either the front wall, the right wall, the left wall or the left wall which provides access to the chamber, the outer fire-resistant door containing fire- and heat-resistant insulation; and
fixing an inner fire-resistant door which provides access to the chamber adjacent to the outer fire-resistant door with an air gap disposed between the inner and the outer fire-resistant doors, the inner fire-resistant door containing fire- and heat-resistant insulation, the roof, the inner and outer doors, the front wall, the right wall, the left wall, the rear wall, the concrete layer, and the base protect the person in the chamber from fire and heat at least in excess of 600 degrees Fahrenheit for at least 2 hours.

25. The method of claim 24 including the step of attaching a fire- and heat-resistant blanket layer to the concrete layer on the front wall, the right wall, the left wall and the rear wall down to the base, and to the concrete layer on the roof.

26. A dolly for a shelter to be towed by a vehicle comprising:
a skeleton on which the shelter is positioned;
a plurality of wheel assemblies attached to the skeleton upon which the shelter rolls; and
an interface attached to and extending from the skeleton to engage with the vehicle and be towed by the vehicle.
